(19) United States
(12) Patent Application Publication
(10) Pub. No.: US 2025/0148040 A1
(43) Pub. Date: May 8, 2025

(54) PATH FINDING SYSTEM FOR ARTIFICIAL INTELLIGENCE MODEL OPTIMIZATION

(71) Applicant: GE Precision Healthcare LLC, Waukesha, WI (US)

(72) Inventors: Xiaomeng Dong, Pleasanton, CA (US); Vivek Pinakin Soni, Pleasanton, CA (US); Dwijay Dhananjay Shanbhag, San Ramon, CA (US); Ashok Vardhan Addala, Pleasanton, CA (US); Michael James Potter, Castro Valley, CA (US)

(21) Appl. No.: 18/500,529

(22) Filed: Nov. 2, 2023

(51) Int. Cl. G06F 17/11

(52) U.S. Cl. CPC G06F 17/11

(57) ABSTRACT

One or more systems, devices, computer program products and/or computer-implemented methods of use provided herein relate to a path finding system for AI model optimization. The computer-implemented system can comprise a memory that can store computer-executable components. The computer-implemented system can further comprise a processor that can execute the computer-executable components stored in the memory, wherein the computer-executable components can comprise a graph generation component that can convert an AI model optimization workflow into a path finding graph comprising a plurality of paths that can capture respective relationships between a plurality of optimization tools, wherein the path finding graph can be employed to solve a graph traversal problem for an AI model optimization task based on a model optimization sequence.

### TECHNICAL FIELD

The subject disclosure relates generally to graph theory and, more specifically, to a path finding system for artificial intelligence (AI) model optimization.

### BACKGROUND

Optimizing AI models for faster inferencing speeds can have a direct impact on user experience of AI products. Different AI model optimization tools have diverse requirements and specifications. As a result, organizations tend to invest significant time and expertise to navigate the landscape of optimization tools to keep abreast of the latest AI inferencing technologies. However, due to the fast-evolving nature of such inferencing technologies, new optimization tools can cause less competitive tools to become obsolete, resulting in a major overhaul of existing inferencing benchmarking infrastructures, which can be expensive. Furthermore, unsupported use cases and bugs are frequently encountered within the realm of AI inferencing acceleration.

Accordingly, systems or techniques for efficient optimization of AI models can be desirable.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable a path finding system for AI model optimization are discussed.

According to an embodiment, a system is provided. The system can comprise a memory that can store computer-executable components. The system can further comprise a processor that can execute the computer-executable components stored in the memory, wherein the computer executable-components can comprise a graph generation component that can convert an AI model optimization workflow into a path finding graph comprising a plurality of paths that can capture respective relationships between a plurality of optimization tools, wherein the path finding graph can be employed to solve a graph traversal problem for an AI model optimization task based on a model optimization sequence.

According to another embodiment, a computer-implemented method is provided. The computer-implemented method can comprise converting, by a device operatively coupled to a processor, an AI model optimization workflow into a path finding graph comprising a plurality of paths that can capture respective relationships between a plurality of optimization tools.

According to yet another embodiment, a computer program product for AI model inferencing optimization is provided. The computer program product can comprise a computer readable storage medium having program instructions embodied therewith, the program instructions executable by a processor to cause the processor to convert an AI model optimization workflow into a path finding graph comprising a plurality of paths that can capture respective relationships between a plurality of optimization tools.

### BRIEF DESCRIPTION OF THE DRAWINGS

One or more embodiments are described below in the Detailed Description section with reference to the following drawings:

FIG. 1 illustrates a block diagram of an example, non-limiting system that can enable a path finding system for AI model optimization in accordance with one or more embodiments described herein.

FIG. 2 illustrates a flow diagram of an example, non-limiting workflow that can generate a path finding system for AI model optimization in accordance with one or more embodiments described herein.

FIG. 3 illustrates a table showing an example, non-limiting specification catalog that can be generated by a path finding system for AI model optimization in accordance with one or more embodiments described herein.

FIG. 4 illustrates a diagram of an example, non-limiting path finding graph that can be generated by a path finding system for AI model optimization in accordance with one or more embodiments described herein.

FIG. 5 illustrates a flow diagram of an example, non-limiting process of graph solving employed by a path finding system for AI model optimization in accordance with one or more embodiments described herein.

FIG. 6 illustrates a diagram of an example, non-limiting path finding graph employed for multipath model optimization in accordance with one or more embodiments described herein.

FIG. 7 illustrates a flow diagram of an example, non-limiting method for multipath model optimization using a path finding system in accordance with one or more embodiments described herein.

FIG. 8 illustrates a flow diagram of an example, non-limiting method for Spanning Tree model optimization using a path finding system in accordance with one or more embodiments described herein.

FIG. 9 illustrates a flow diagram of an example, non-limiting process of inserting an optimization node in a path finding graph for AI model optimization in accordance with one or more embodiments described herein.

FIG. 10 illustrates a diagram of an example, non-limiting path finding graph for alternative path rerouting for optimization of an AI model in accordance with one or more embodiments described herein.

FIG. 11 illustrates example, non-limiting results generated by a path finding system by employing a path finding graph to optimize AI models developed for the X-Ray domain in accordance with one or more embodiments described herein.

FIG. 12 illustrates example, non-limiting results generated by a path finding system by employing a path finding graph to optimize AI models developed for the magnetic resonance imaging (MRI) domain in accordance with one or more embodiments described herein.

FIG. 13 illustrates example, non-limiting results generated by a path finding system by employing a path finding graph to optimize an AI model developed for image segmentation in accordance with one or more embodiments described herein.

FIG. 14 illustrates example, non-limiting graphs of inference times and recon lag results comparisons for an AI model before and after optimization of the AI model in accordance with one or more embodiments described herein.

FIGS. 15-19 illustrate example, non-limiting images generated by respective AI models before and after optimization of the respective AI models in accordance with one or more embodiments described herein.

FIGS. 20-25 illustrate example, non-limiting results generated by a path finding system by employing a path finding graph to optimize respective AI models on virtual machines (VMs) and actual hardware in accordance with one or more embodiments described herein.

FIG. 26 illustrates a flow diagram of an example, non-limiting method that can enable a path finding system for AI model optimization in accordance with one or more embodiments described herein.

FIG. 27 illustrates a block diagram of an example, non-limiting operating environment in which one or more embodiments described herein can be facilitated.

FIG. 28 illustrates an example networking environment operable to execute various implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

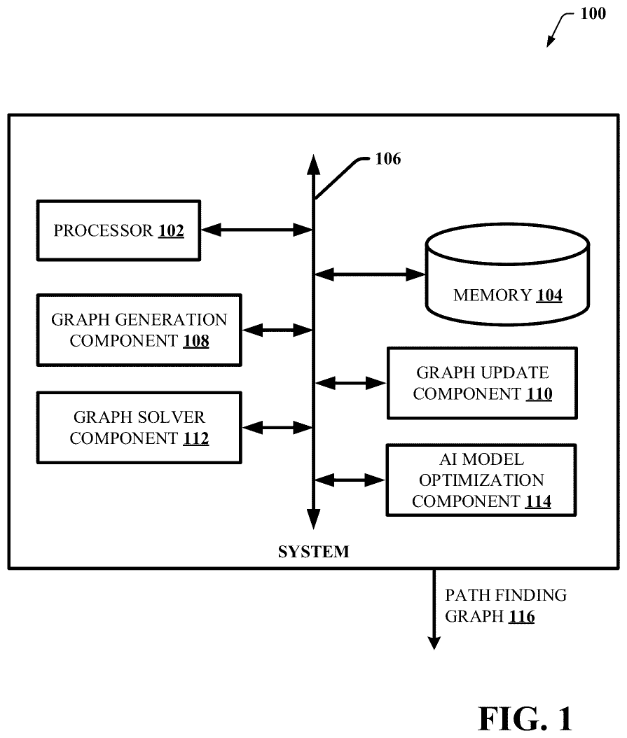

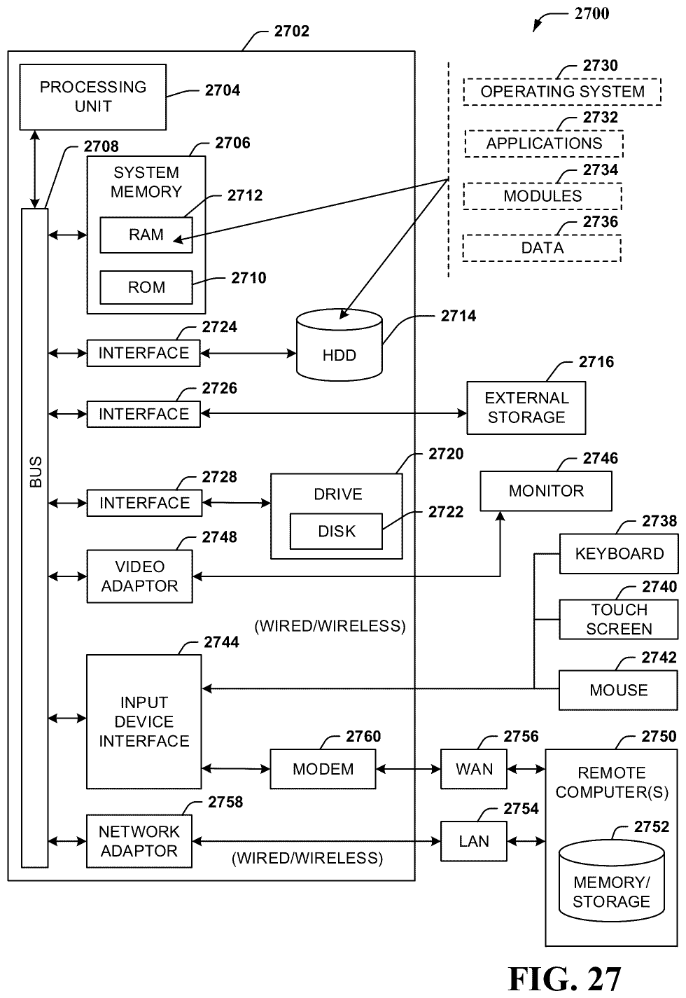

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 2700 illustrated at FIG. 27. For example, system 100 can be associated with, such as accessible via, a computing environment 2700 described below with reference to FIG. 27, such that aspects of processing can be distributed between system 100 and the computing environment 2700. In one or more described embodiments, computer and/or computing-based elements can be used in connection with implementing one or more of the systems, devices, components and/or computer-implemented operations shown and/or described in connection with FIG. 1 and/or with other figures described herein.

AI model optimization is a highly evolving field with different optimization tools having diverse requirements and specifications. Optimizing AI models for faster inferencing speeds can have a direct impact on user experience of an AI product. As a result, a company needs to invest major time and expertise to navigate through the landscape of optimization tools to stay up to date with current AI inferencing technologies. In the meantime, due to the fast-evolving nature of inferencing solutions, newly emerging optimization tools often cause less competitive tools to gradually lose their advantages and eventually become obsolete. Such a scenario can result in a major overhaul of an existing inferencing benchmarking infrastructure, causing a company to incur additional development costs. Furthermore, unsupported use cases and bugs are frequently encountered in the field of AI inferencing acceleration, which can pose a major risk to product timelines when leveraging any specific optimization workflow.

Due to AI optimization being a highly evolving field, existing optimization tools or methods for optimizing AI models are constantly evolving, which can introduce complications and challenges for a company in attempting to remain at par with latest methodologies for optimizing AI models for speed and resource usage. Direct optimization tools only focus on optimization over a limited scope, such as for a particular model format (like Open Neural Network Exchange (ONNX) Runtime for Microsoft®) or for specific hardware (like TensorRT™ for NVIDIA® GPU or OpenVINO™ for Intel® CPU). That is, existing optimization tools only serve respective model formats or respective vendor (e.g., TensorRT™ developed by NVIDIA® only serves NVIDIA® GPU, OpenVINO™ developed by Intel® is only designed to work on Intel®, etc.). However, for companies having a wide variety of product system specifications (both in terms of hardware and software), existing solutions for any specific hardware/software stack cannot generalize to an entire product line. Further, an existing AI model optimization technology follows a pre-determined workflow, wherein adding a new inferencing technology to an existing system is likely to require a major system redesign. This presents difficulties to the existing system in attempting to remain up to date with emerging AI acceleration technology. Furthermore, newer optimization engines are introduced in the market every year, which can add an additional level of challenge for companies attempting to find the best optimization workflows, manually. Thus, a general solution that can ensure that existing AI products can integrate latest technologies and remain competitive can be desirable.

Embodiments described herein include systems, computer-implemented methods, and computer program products that can overcome one or more of the problems mentioned above by translating AI optimization into a path finding system. Various embodiments can capture inter-relations between different optimization tools for translating a model optimization workflow into a mathematical graph system that can provide a systematic approach for coordinating the different optimization tools and significantly reducing time and expertise needed for performing AI model optimizations. The path finding system can also provide the flexibility of adding or removing optimization tools from an existing system, such that a new technology can be incorporated into the existing system without requiring additional redesign of the existing system. The graph-based approach of the path finding system can offer multiple paths for achieving AI model optimization by graph traversal, effectively reducing a risk of AI deployment caused by bugs or unsupported operations.

In various embodiments, the path finding system can include a workflow consisting of three iterative steps in a cycle that can be repeated to incorporate any new technology into an existing system for AI model optimization. The three iterative steps can include as a first step, specification cataloging, as a second step, path building, and as a third step, graph solving. In some examples, the path finding system can include a workflow with any suitable number of iterative sequences of instructions, actions, or blocks.

In various embodiments, during specification cataloging, specific characteristics such as, for example, a operating system (OS), hardware, vendor dependency, tuning parameters, etc., of an AI model optimization tool, can be organized by the path finding system in a standardized catalog for later use. During path building, inter-relationships between different optimization tools and file formats of the different optimization tools can be summarized and stored by the path finding system in a systematic way. For example, TensorFlow™ and ONNX can be two of the optimization tools considered by the path finding system and based on existence of a possible conversion path from TensorFlow™ to ONNX, a graph generation component can build a directional edge between TensorFlow™ and ONNX. Eventually, the path finding system can generate a graph system (e.g., path finding graph system/path finding graph/mathematical graph system) that can systematically represent every optimization tool in a map.

In various embodiments, during graph solving, given a particular model optimization request, the workflow of the path finding system can first prune unrelated optimization tools from the path finding graph based on specifications (e.g., OS, hardware, etc.) for the model optimization request. Next, the path finding system can treat the remaining optimization tools in the graph system as nodes, and an optimization problem can be translated into a mathematical graph problem. Thereafter the path finding system can apply a graph solver to the graph system to find a solution to a graph traversal problem. For example, “find all possible optimization options starting from a TensorFlow™ model on an NVIDIA® GPU” can be viewed as a graph traversal problem. Finally, the path finding system can translate the solution to the graph traversal problem back to the domain of AI optimization. After solving the graph, the model optimization can begin in a sequence, eventually achieving the objective of optimizing an AI model with the various optimization tools comprised in the graph system and summarizing different options.

Once built, the path finding system can, enable four workflows, namely, multipath model optimization, spanning tree model optimization, optimization node insertion/removal and alternative path rerouting.

In various embodiments, multipath model optimization can be a workflow that can solve a specific target optimization problem by finding all viable paths from one optimization tool to another in the path finding graph in an automatic and robust way. The workflow of multipath model optimization can involve initializing the path finding graph followed by node pruning based on constraints to generate an updated path finding graph, solving the updated path finding graph and executing optimizations for solving the target optimization problem. Optimization of a specific target can happen when a user starts from an AI model of any format and wants to optimize the AI model to a specific target framework while conditioning the AI model on inferencing deployment constraints. For example, given a TensorFlow™ model, a user can aim to optimize the TensorFlow™ model to an OpenVINO™ model such that the TensorFlow™ model can run on the CPU of a Linux® machine.

In various embodiments, Spanning Tree model optimization can be a workflow that can address open-ended AI optimization needs, and the workflow can operate by introducing an additional graph traversal workflow, known as meta graph search, that can search all non-repeated connected nodes in the path finding graph through viable paths. The workflow of the Spanning Tree model optimization can be a generalization of the workflow of the multipath model optimization of a specific target. Spanning Tree model optimization can address a scenario wherein a user can start from an AI model of any format without providing any specific optimization target. The path finding system can then evaluate all viable nodes in the path finding graph that can be reached via connected paths under user-defined constraints. For example, a user can provide a PyTorch® model with the intention to evaluate all available optimization options for a NVIDIA® GPU with a maximum error less than 0.005. Such an optimization exploration can significantly reduce the expertise needed from an end user to perform model optimization because the Spanning Tree model optimization workflow can turn AI model optimization into a fully automated workflow and not require any prior knowledge about existence of model optimization frameworks or methods.

In various embodiments, an optimization node insertion/removal workflow can allow for an easy and flexible way of integrating any emerging AI optimization technology with an existing system for AI model optimization, which can assist companies and organizations to keep their AI products competitive while minimizing a development cost. In this regards, insertion or removal of optimization nodes can respectively refer to integrating or deleting an optimization technology or an optimization tool from the existing system for AI model optimization. Integrating a new optimization solution (e.g., a new optimization tool) can only involve registering a node (e.g., the new optimization tool) to the existing system (according to characteristics of the optimization tool in a standardized catalog, as described above). Thereafter, a corresponding conversion function can be added to capture relations between the new optimization solution and existing optimization nodes of the existing system. Thus, the node insertion/removal workflow can offer a unique way of integrating or deleting optimization tools without requiring a system-level redesign.

The alternative path rerouting workflow can automatically reroute from an original path to an alternative path that can achieve an optimization goal when the original path is blocked due to bugs/error. As discussed above, model optimization being a fast-evolving field in AI, bugs and unsupported use cases can be frequently encountered, and the alternative path rerouting workflow can address such concerns in the model optimization landscape. When combining multipath optimization with the path rerouting workflow in model optimization, the overall system can be less likely to be blocked by any specific bugs or unsupported use cases, significantly reducing risks during an AI product development lifecycle.

Thus, various embodiments herein can provide a generalized system that can ensure that AI products can remain at par with the latest and best AI technologies available in the market. Various embodiments herein can combine a variety of optimization tools in one system and interact with the different optimization tools to provide a systematic approach to AI optimization. In contrast to some existing AI optimization methods such as discussed above, the various embodiments herein can integrate arbitrary technologies in an existing system in a relatively easier manner due to path-based optimization node insertion. Additionally, the various embodiments herein can provide a system that can consume a variety of direct optimization tools in a systematic manner, such that the system can operate on a higher hierarchy that can cover a wider spectrum of system specifications (e.g., than a direct optimization tool), that can allow companies to serve AI products in a generalized fashion. The various embodiments herein can incorporate a wide scope in terms of both, model optimization technologies, and possible optimization paths. Further, the various embodiments herein can handle a greater number of problems in comparison to some existing AI optimization solutions.

An optimization workflow enabled by the various embodiments herein can allow for hardware specific model optimization, which can unlock additional speed and resource usage potential for an AI model. For example, various embodiments herein can provide technical improvements to AI systems by improving inferencing speeds of AI models, reducing resource utilization of AI models when performing inferences and/or reducing resource usage during AI development, etc. In addition, various embodiments herein can lower hardware requirements needed to deploy a neural network by reducing memory usage of the neural network, and cause the neural network to generate outputs faster. Moreover, the hardware specific model optimization can provide an opportunity for Just-in-Time (JiT)-based model optimization workflows that can potentially provide benefits from a regulatory filing perspective when deploying models onto new hardware. The various embodiments herein can be incorporated in a product that can be utilized for AI models in the healthcare industry or for AI models in other industries.

Turning now to FIG. 1, illustrated is a block diagram of an example, non-limiting system 100 that can enable a path finding system for AI model optimization in accordance with one or more embodiments described herein.

System 100 and/or the components of system 100 can be employed to use hardware and/or software to solve problems that are highly technical in nature (e.g., related to graph theory, optimizing AI models by employing a path finding graph, etc.), that are not abstract and that cannot be performed as a set of mental acts by a human. Further, some of the processes performed may be performed by specialized computers for carrying out defined tasks related to optimization of AI models by converting an AI model optimization workflow to a path finding graph. The system 100 and/or components of system 100 can be employed to solve new problems that arise through advancements in technologies mentioned above, AI model optimization tools, and/or the like. System 100 can provide technical improvements to AI systems by improving inferencing speeds of AI models, reducing resource utilization of AI models when performing inferences and/or reducing resource usage during AI development, etc. In addition, system 100 can lower hardware requirements needed to deploy a neural network by reducing memory usage of the neural network, and cause the neural network to generate outputs faster.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., graph generation component 108, graph update component 110, graph solver component 112, and/or AI model optimization component 114) to perform one or more actions. In one or more embodiments, memory 104 can store computer-executable components (e.g., graph generation component 108, graph update component 110, graph solver component 112, and/or AI model optimization component 114).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In various embodiments, system 100 can be a path finding system. As described above, in addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, in various embodiments, graph generation component 108 can convert an AI model optimization workflow into path finding graph 116 comprising a plurality of paths that can capture respective relationships between a plurality of optimization tools, wherein path finding graph 116 can be employed to solve a graph traversal problem for an AI model optimization task based on a model optimization sequence. In various embodiments, the path finding graph can be employed towards optimization of AI models. For example, AI models can be developed by companies for a variety of situations. For example, some AI models can be segmentation models, wherein a segmentation model can be an AI model developed for segmenting a region of interest on a medical image, for highlighting a specific area of the medical image, to assist a radiologist viewing the medical image in making a diagnosis. Such a segmentation model can be integrated in a device in a real-time manner. For example, an ultrasound device can display ultrasound images, and an AI model can perform inferencing on every frame of an ultrasound image displayed by the ultrasound device to identify and highlight a region of interest for a radiologist.

Often, such AI models can need optimization for speed and resource usage during deployment. Optimization herein can refer to optimization of hardware level execution parameters as opposed to, for example, optimization typically referenced in the context of model training. The hardware level execution parameters can comprise, for example, parameters on a graphics processing unit (GPU) that can make an AI model operate as fast as possible (e.g., cause the AI model to make inferences as fast as possible) and parameters that can make the AI model consume as less resources (e.g., GPU memory) as possible. Such optimizations can be performed on the AI models by optimization tools. Optimization tools can be software that can interact with an AI model to make the AI model perform better and more efficiently with corresponding hardware. Path finding graph 116 generated by graph generation component 108 can comprise a plurality of optimization tools, wherein respective optimization tools can be nodes of path finding graph 116. In various embodiments, respective paths of the plurality of paths of path finding graph 116 can represent respective possibilities of conversions between optimization tools.

For generating path finding graph 116, graph generation component 108 can first generate a specification catalog based on existing optimization methodologies or optimization tools available in the market. For example, different vendors or different companies can create vendor specific optimization tools for respective vendor specific hardware, and graph generation component 108 can use the vendor specific optimization tools to generate the specification catalog. The specification catalog can be a catalog of information or features of optimization tools that can be considered for optimizing AI models. For example, for a specific optimization tool, the specification catalog can comprise information about an OS required by the optimization tool, hardware associated with the optimization tool, a vendor of the optimization tool, tuning parameters that the optimization tool can offer, hardware specificity, etc. Hardware specificity can be a feature that can identify how specific the optimization tool can be to the hardware that the optimization tool can support and whether the optimization tool has a strict hardware requirement, etc. Various embodiments herein can utilize such information to build a general system (e.g., path finding graph 116) comprising a variety of optimization tools, and system 100 (e.g., one or more components of system 100) can navigate through the different optimization tools to optimize AI models.

In various embodiments, after adding the different optimization tools to the specification catalog and storing relevant characteristics of the different optimization tools in the specification catalog, system 100 can build path finding graph 116. In path finding graph 116, inter-relationships between different optimization tools and file formats of the different optimization tools can be summarized and stored by the graph generation component 108 in a systematic way. There can be many ways to store path finding graph 116 in a program. In various embodiments, path finding graph 116 can be stored as a linked list which is a type of a data structure, and path finding graph 116 can be stored in a program. For example, TensorFlow™ and ONNX can be two of the optimization tools considered by the path finding system and based on existence of a possible conversion path from TensorFlow™ to ONNX, graph generation component 108 can build a directional edge between TensorFlow™ and ONNX. Eventually, graph generation component 108 can generate path finding graph 116 that can systematically represent every optimization tool from the specification catalog in a map. For example, as stated above, respective optimization tools can have different characteristics and certain inter-relations.

More specifically, during path building, if one optimization tool can take the outcome of another optimization tool, graph generation component 108 can build an edge (e.g., a unidirectional edge or a bidirectional edge) between the two optimization tools, and eventually build a map comprising different optimization tools that system 100 can navigate. For example, graph generation component 108 can navigate through the respective optimization tools and if an inter-relation exists between two optimization tools (e.g., one tool can take the outcome of another optimization tool), graph generation component 108 can build an edge or bridge between the two optimization tools. Thus, each optimization tool can have a respective location on the map (e.g., path finding graph 116) and respective optimization tools can be connected by respective paths to generate the path finding graph 116.

In various embodiments, upon generation of path finding graph 116, system 100 can perform graph solving, wherein system 100 can employ path finding graph 116 to execute various workflows. For example, as discussed above, given a particular model optimization request, the workflow of system 100 can first prune (e.g., using graph update component 110) unrelated optimization tools from path finding graph 116 based on specifications (e.g., OS, hardware, etc.). Next, system 100 can treat the remaining optimization tools in path finding graph 116 (e.g., updated path finding graph 116) as nodes, and an optimization problem can be translated into a mathematical graph problem. Thereafter, system 100 can apply AI model optimization component 114 to path finding graph 116 to find a solution to the optimization problem. For example, after solving path finding graph 116, model optimization can begin in a sequence, eventually achieving an objective of optimizing an AI model and summarizing different options.

More specifically, upon generation of path finding graph 116 based on identification of respective locations for respective optimization tools (e.g., by graph generation component 108) in path finding graph 116 and establishing bridges between the respective optimization tools in path finding graph 116, system 100 can employ path finding graph 116 to solve optimization problems. For example, system 100 can employ path finding graph 116 for making an AI model faster (e.g., making the AI model have greater inferencing speed) and more efficient in terms of resource consumption. Path finding graph 116 can assist system 100 to solve optimization problems with greater ease. For example, by employing path finding graph 116, optimization problems can be translated into graph problems that can be well-defined sets of problems. Stated differently, given the specification catalog and characteristics of various optimization tools, and given path finding graph 116, system 100 can translate an AI model optimization problem into a graph traversal problem, and system 100 can solve the graph traversal problem by using graph solver methods. For example, finding potential optimizations for an AI model starting from an optimization tool on a particular specific hardware can be a graph traversal problem that can be solved by system 100. Further, upon solving the graph traversal problem, system 100 can translate the solution back to the AI optimization domain. After solving path finding graph 116, system 100 can begin AI model optimization based on a model optimization sequence, and results of the AI model optimization performed can be summarized by system 100 and presented to a user.

The model optimization sequence can refer to a sequence in which system 100 can traverse path finding graph 116. For example, system 100 can employ graph solver component 112 to traverse path finding graph 116 between nodes. A determination of an order in which graph solver component 112 can traverse path finding graph 116 can be based on the model optimization sequence, and the model optimization sequence can be relevant since certain nodes in path finding graph 116 can only be connected through one or more other nodes. In other words, using the model optimization sequence, graph solver component 112 can determine the correct order of travelling through path finding graph 116 for solving a graph traversal problem. As stated above, finding all possible optimizations starting from one optimization tool to another can be viewed as a graph traversal problem. Upon solving the graph traversal problem, system 100 can translate the solution back to a domain of the optimization tools. For example, graph solver component 112 can begin traversing path finding graph 116 from a first node (e.g., corresponding to a TensorFlow™ model), wherein path finding graph 116 can comprise several nodes (i.e., optimization tools) that can be connected to the TensorFlow™ model. The TensorFlow™ model is a well-known development framework that is often a starting point for many AI models. From the first node, graph solver component 112 can traverse to a second node (e.g., corresponding to an ONNX model), and from the second node, graph solver component 112 can traverse to a third node (e.g., corresponding to a TensorRT™ model) based on a model optimization sequence. Upon solving graph traversal problem, system 100 can translate the solution back to the domain of AI optimization.

At each node that graph solver component 112 can traverse to, system 100 can employ AI model optimization component 114 to solve the optimization problem (e.g., optimize an AI model) using an optimization tool forming the node of path finding graph 116. Graph solver component 112 can travel to each node in path finding graph 116 and at each node, system 100 can benchmark an inferencing speed of the AI model optimized by AI model optimization component 114 using the optimization tool forming a respective node. For example, system 100 can traverse path finding graph 116 and visit all nodes that an original optimization tool (e.g., starting point in path finding graph 116 associated with an AI model to be optimized) can be connected to, and system 100 can systematically benchmark results of optimizing the AI model at respective nodes, followed by presenting the results in a table-like format.

It is to be appreciated that graph solver component 112 can be initially unaware as to which node is the best to traverse to, from a particular node. However, based on the model optimization sequence, graph solver component 112 can determine an order of traversing path finding graph 116. Traversing path finding graph 116 can involve a consideration of how various optimization tools can be connected in path finding graph 116. For example, if two optimization tools in path finding graph 116 are not connected by any path, graph solver component 112 can make a decision to not traverse between the two optimization tools. Traversing path finding graph 116 can also be based on certain common rules of thumb. For example, path finding graph 116 can comprise certain nodes that can be more versatile (e.g., all-rounder nodes), and preference can be given to such versatile nodes by graph solver component 112. For example, ONNX can be known as an all-rounder node because several AI frameworks can accept ONNX, and additional heuristics of prioritizing traversal through ONNX can be considered by graph solver component 112. Further, additional rules based on preference, that can be provided by a user/developer of system 100, can also be consider by graph traversal component. Thus, connectivity of nodes and rules can be considered by graph solver component 112 for traversing path finding graph 116.

In various embodiments, AI model optimization component 114 can use path finding graph 116 to optimize an AI model based on an optimization requirement provided by a user via a multipath model optimization workflow. In various embodiments, the multipath model optimization workflow can solve a specific target optimization problem (e.g., AI model optimization problem) by finding all viable paths from one optimization tool to another in the path finding graph in an automatic and robust way. For example, optimization tools, TensorFlow™ (TF) Keras and OpenVINO™, can form nodes of path finding graph 116, such that there can be multiple paths for traversing path finding graph 116 from TF Keras to OpenVINO™. Graph solver component 112 can identify potential paths from TF Keras to OpenVINO™, and graph solver component 112 can traverse the potential paths in a systematic way (e.g., based on connectivity and rules). The multipath model optimization workflow can involve initializing path finding graph 116, followed by node pruning based on constraints, solving the path finding graph and executing optimizations for solving the target optimization problem.

Optimization based on a specific target can imply that a user can provide an AI model in any format to system 100 for optimizing the AI model to a specific target framework while conditioning the AI model on inferencing deployment constraints. For example, given a TensorFlow™ model, a user can aim to optimize (e.g., using system 100) the TensorFlow™ model to an OpenVINO™ model such that the TensorFlow™ model can run on the CPU of a Linux® machine. As described elsewhere herein, node pruning can imply that for certain characteristics of an AI model to be optimized, certain nodes of path finding graph 116 can be irrelevant. For example, in the domain of AI optimization, if an optimization tool can only work on a particular hardware, and a user desires to optimize an AI model to a different hardware, then the node associated with the optimization tool can be pruned (e.g., by graph update component 110). For example, ONNX only works on a central processing unit (CPU) not GPU. Thus, if a user desires to optimize an AI model to a GPU, graph update component 110 can prune ONNX out of path finding graph 116, such that any operations going through ONNX will not be displayed to the user. After optimizing an AI model at one node, AI model optimization component 114 can move to another node.

In various embodiments, AI model optimization component 114 can use path finding graph 116 to optimize the AI model without the optimization requirement provided by the user via a Spanning Tree model optimization workflow. In various embodiments, the Spanning Tree model optimization workflow can address open-ended AI optimization needs. The Spanning Tree model optimization workflow can operate by introducing a graph traversal workflow, known as meta graph search, in addition to the multipath model optimization workflow, wherein the meta graph search can search all non-repeated connected nodes through viable paths in path finding graph 116. For example, graph solver component 112 can loop through all possible connected paths in path finding graph 116 and perform a meta graph search, which can be a nested loop. Thus, the Spanning Tree model optimization workflow can be a generalization of the multipath model optimization workflow of a specific target.

The Spanning Tree model optimization workflow can address a scenario wherein a user can start from an AI model of any format without providing any specific optimization target. System 100 can then evaluate all viable nodes in path finding graph 116 that can be reached via connected paths under user-defined constraints. For example, a user can provide a PyTorch® model with the intention to evaluate all available optimization options for a NVIDIA® GPU with a maximum error less than 0.005. Such an optimization exploration can significantly reduce the expertise needed from an end user to perform model optimization because the Spanning Tree model optimization workflow can turn model optimization into a fully automated workflow and not require any prior knowledge about existence of model optimization frameworks or methods. Thus, the Spanning Tree model optimization workflow can allow users to explore (e.g., using system 100) various optimization solutions that can exist for optimizing an AI model, without requiring information about an optimization target from the user.

The Spanning Tree model optimization workflow can need a smaller number of parameters than the multipath model optimization workflow because the multipath model optimization workflow can require a user to have some knowledge of an optimization end goal and what the best parameters can be for a particular task. As such, in case of the Spanning Tree model optimization workflow, a user can provide an AI model to be optimized and some constraints to system 100, and system 100 can loop through potential optimization tools in path finding graph 116 while solving path finding graph 116 and executing optimizations. Eventually, system 100 can compile all results together as a summary. This process can be known as Spanning Tree optimization. The constraints provided by the user to system 100 can comprise information about hardware (e.g., CPU or GPU) that the AI model is to be optimized for, some information about the AI model (e.g., input data type, number of inputs, an input shape of the AI model, etc.) that can be needed for different optimization tools or frameworks for the optimization of the AI model to continue, and so on.

In various embodiments, graph update component 110 can update path finding graph 116 by addition or removing one or more optimization tools without performing a system-level redesign. Thus, system 100 can integrate new technologies or delete existing technologies seamlessly. For example, a new optimization tool created by a company can become available in the market, and graph update component 110 can integrate the new optimization tool in path finding graph 116 (e.g., an existing path finding graph system) by drawing bridges/edges between the new optimization tool and existing optimization tools in path finding graph 116, such that an existing overall design of path finding graph 116 can continue to operate without needing any changes. In other words, path finding graph 116 can continue to operate as before from one node to another node, even after addition of the new optimization tool. Likewise, if a company responsible for an optimization tool comprised in path finding graph 116 declares that the optimization tool is no longer supported by the company, the optimization tool can be removed from path finding graph 116 by graph update component 110, and path finding graph 116 can continue to operate without requiring further changes. Thus, in various embodiments, system 100 can enable seamless addition and/or removal of optimization tools (e.g., nodes). The node addition/removal can be performed at a program level at the end of a developer of system 100. As stated elsewhere herein, path finding graph 116 can be a data structure and new optimization tools can be added by graph update component 110 as nodes in the data structure, causing path finding graph 116 to be updated. The nodes of path finding graph 116 can be part of a node register. At the side of an end user, graph update component 110 can perform node pruning, as discussed in various embodiments herein.

In various embodiments, graph solver component 112 can perform alternative path rerouting during optimizing of AI models. For example, graph solver component 112 can reroute from a first path to a second path in path finding graph 116, during traversal of path finding graph 116 for optimization of an AI model, to avoid bugs or errors in the first path. Alternative path rerouting can be an extension of the multipath model optimization workflow described above. For example, as discussed with reference to the multipath model optimization workflow, path finding graph 116 can offer multiple routes from one optimization tool to another. In path finding graph 116, certain paths from a first optimization tool to a second optimization tool can become blocked due to bugs, errors, and/or unsupported use cases, etc. In such a scenario, graph solver component 112 can traverse all paths from the first optimization tool to the second optimization tool to identify an error-free path between the first optimization tool and the second optimization tool. AI optimization being a highly evolving field wherein optimization tools can be under active development and upgrade respective vendor companies, bugs can occur in paths of path finding graph 116. Bugs can be any human mistake made in a program, wherein the mistake can cause the program to not behave in an expected manner. For example, bugs can prevent an operation of an AI model from optimizing, which can be equivalent to a mathematical operator being unsupported. In another example, new upgrades to a software can cause an operator to be inconsistent with an earlier model. That is, originally, the model can be capable of producing a certain result, however, after an upgrade, a bug can be introduced into the model, and the upgraded version of the model can produce a different result from the original result.

In various embodiments, path finding graph 116 can allow for optimizing an AI model to have an inferencing speed greater than a first defined threshold and resource usage lower than a second defined threshold, and the AI model (e.g., the optimized AI model) can be integrated with medical imaging devices to provide real-time inferencing of medical images generated by the medical imaging devices. Inferencing speeds of AI models can be measured by a program. The program can measure wall clock time taken by an AI model between a starting point and an ending point of an inferencing task. The wall clock time can be measured multiple times and statistical results (e.g., average and standard deviation values) can be generated to determine whether improvements in an inferencing speed of the AI model have occurred. Resource usage of an optimized AI model can be similarly measured. For example, the program can automatically measure GPU memory consumed by the AI model. Optimizing AI models using system 100 can change an AI model from a software perspective without changing a mathematical operation of the AI model. For example, upon optimization, a mathematical operation of the AI model can employ a different hardware level execution (e.g., a different file that can perform an existing function of the AI model by accessing different hardware entities than before optimization of the AI model). As such, system 100 can enable AI products to remain up to date with latest technologies in the marker, optimize AI models for faster inferencing speeds, enable technology upgrades while maintain lower upgrade costs than manual work and allow efficient usage of resources spent on AI product development.

Additional aspects of the path finding system (e.g., system 100) are disclosed in greater detail with respect to subsequent figures.

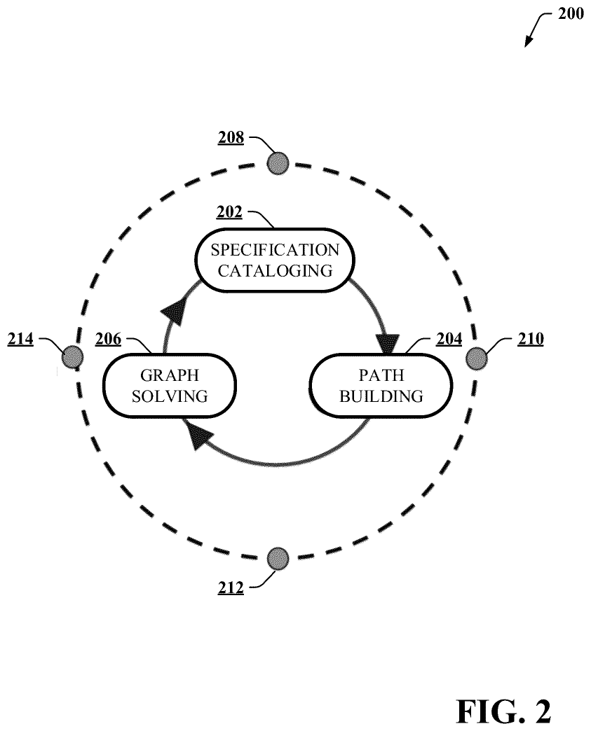

FIG. 2 illustrates a flow diagram of an example, non-limiting workflow 200 that can generate a path finding system for AI model optimization in accordance with one or more embodiments described herein. One or more embodiments discussed with reference to FIG. 2 can be performed by one or more components of system 100 of FIG. 1. Repetitive description of like elements and/or processes employed in respective embodiments is omitted for sake of brevity.

With continued reference to FIG. 1, in various embodiments, a path finding system (e.g., system 100) can capture inter-relations between different optimization tools for translating a model optimization workflow into a mathematical graph system, that can provide a systematic approach for coordinating the different optimization tools and significantly reducing the time and expertise needed for performing AI model optimization. The path finding system can also provide a flexibility of adding or removing optimization tools, such that a new technology can be incorporated without requiring additional redesign of an existing system. The graph-based approach can offer multiple paths for achieving AI model optimization by graph traversal, effectively reducing a risk of AI deployment caused by specific bugs or unsupported operations.

In various embodiments, the path finding system can comprise workflow 200 consisting of three iterative steps in a cycle that can be repeated to incorporate new technologies into an existing system for AI model optimization. The three iterative steps can include at 202, specification cataloging, at 204, path building, and at 206, graph solving.

During specification cataloging at 202, specific characteristics such as, for example, an OS, hardware, vendor dependency, tuning parameters, etc., of an AI model optimization tool, can be organized by the path finding system in a standardized catalog for later use. During path building at 204, inter-relationships between different optimization tools and file formats of the different optimization tools can be summarized and stored by the path finding system in a systematic way. For example, TensorFlow™ and ONNX can be two of the optimization tools considered by the path finding system and based on existence of a possible conversion path from TensorFlow™ to ONNX, the path finding system can build (e.g., using graph generation component 108) a directional edge (e.g., unidirectional edge or bidirectional edge) between TensorFlow™ and ONNX. Eventually, the path finding system can generate a path finding graph (e.g., path finding graph 116) that can systematically represent every optimization tool in a map.

During graph solving at 206, given a particular model optimization request, the workflow of the path finding system can first prune unrelated optimization tools from the path finding graph based on specifications (e.g., OS, hardware, etc.). Next, the path finding system can treat the remaining optimization tools in the path finding graph as nodes and translate an optimization problem into a mathematical graph problem. Thereafter, the path finding system can apply a graph solver (e.g., graph solver component 112) to the path finding graph to find a solution to the mathematical graph problem. The mathematical graph problem can be a graph traversal problem. For example, the path finding system can solve a graph traversal problem of finding potential optimization paths in the path finding graph from a first optimization tool on a specific hardware (e.g., GPU). The path finding system can solve the graph traversal problem and the solution can be translated back to a domain of AI optimization. After solving the graph traversal problem, the path finding system can begin optimization of the AI model in a sequence, based on a model optimization sequence, eventually achieving an optimization objective for the AI model and summarizing different options.

Once built, the path finding system can, enable four workflows, namely, multipath model optimization (at 208), spanning tree model optimization (at 210), optimization node insertion/removal (at 212) and alternative path rerouting (at 214). Additional aspects of generating the path finding graph by workflow 200 are disclosed with reference to subsequent figures.

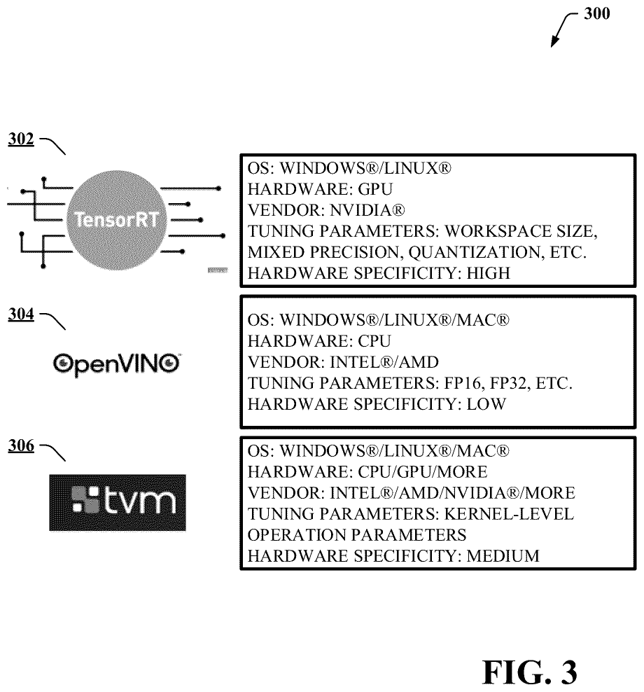

FIG. 3 illustrates a table showing an example, non-limiting specification catalog 300 that can be generated by a path finding system for AI model optimization in accordance with one or more embodiments described herein. One or more embodiments discussed with reference to FIG. 3 can be performed by one or more components of system 100 of FIG. 1. Repetitive description of like elements and/or processes employed in respective embodiments is omitted for sake of brevity.

With continued reference to FIG. 1, for generating path finding graph 116, graph generation component 108 can first generate specification catalog 300 based on existing optimization methodologies or optimization tools available in the market. For example, different vendors or different companies can create vendor specific optimization tools for respective vendor specific hardware, and graph generation component 108 can use the vendor specific optimization tools to generate specification catalog 300. Specification catalog 300 can be a catalog of information or features of optimization tools that can be considered for optimizing AI models. For example, for a specific optimization tool, specification catalog 300 can comprise information about an OS required by the optimization tool, hardware associated with the optimization tool, a vendor of the optimization tool, tuning parameters that the optimization tool can offer, hardware specificity, etc. Hardware specificity can be a feature that can identify how specific the optimization tool can be to the hardware that the optimization tool can support and whether the optimization tool has a strict hardware requirement, etc. Various embodiments herein can utilize such information to build a general system (e.g., path finding graph 116) comprising a variety of optimization tools, and system 100 can navigate through the different optimization tools to optimize AI models.

For example, as illustrated in FIG. 3, specification catalog 300 can comprise specific characteristics of optimization tool 302, optimization tool 304 and optimization tool 306. In various embodiments, specification catalog 300 can comprise additional optimization tools. Optimization tool 302 can be a TensorRT™ model developed by the vendor NVIDIA® and utilizing a Windows®/Linux® OS, a GPU as hardware, workspace size, mixed precision, quantization, etc. as tuning parameters, and having a high hardware specificity. Optimization tool 304 can be an OpenVINO™ model developed by the vendors Intel®/Advanced Micro Devices (AMD) and utilizing a Windows®/Linux®/Mac® (by Apple®) OS, a CPU as hardware, FP16, FP32, etc. as tuning parameters, and having a low hardware specificity. Optimization tool 306 can be an Apache Tensor Visual Machine (Apache TVM™) model developed by the vendors Intel®/AMD/NVIDIA®/others and utilizing a Windows®/Linux®/Mac® OS, a CPU/GPU/other hardware as hardware, kernel-level operation parameters, etc. as tuning parameters, and having a medium hardware specificity.

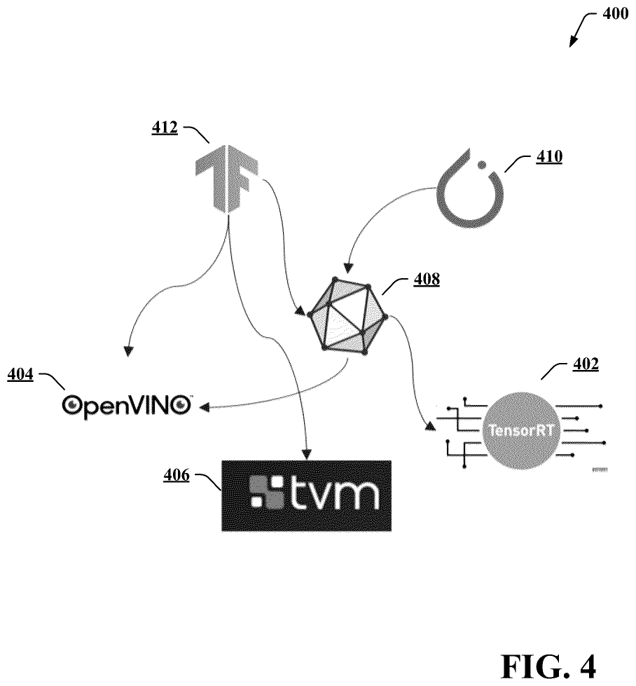

FIG. 4 illustrates a diagram of an example, non-limiting path finding graph 400 that can be generated by a path finding system for AI model optimization in accordance with one or more embodiments described herein. One or more embodiments discussed with reference to FIG. 4 can be performed by one or more components of system 100 of FIG. 1. Repetitive description of like elements and/or processes employed in respective embodiments is omitted for sake of brevity.

With continued reference to FIG. 1, in various embodiments, system 100 can build path finding graph 116. Path finding graph 400 can be an example of path finding graph 116 that can be built by system 100. In path finding graph 400, inter-relationships between different optimization tools and file formats of the different optimization tools can be summarized and stored by graph generation component 108 in a systematic way. There can be many ways to store path finding graph 400 in a program. In various embodiments, path finding graph 400 can be stored as a linked list which is a type of a data structure, and path finding graph 400 can be stored in a program. For example, TensorFlow™ (at 412) and ONNX (at 408) can be two of the optimization tools considered by the path finding system and based on existence of a possible conversion path from TensorFlow™ to ONNX, graph generation component 108 can build a directional edge between TensorFlow™ and ONNX. Eventually, graph generation component 108 can generate a graph system (e.g., path finding graph 116) that can systematically represent every optimization tool from the specification catalog in a map. For example, in addition to TensorFlow™ and ONNX, path finding graph can comprise, PyTorch® (at 410), TensorRT™ (at 402), TVM™ (at 406) and OpenVINO™ (at 404).

Thus, during path building, if one optimization tool can take the outcome of another optimization tool, graph generation component 108 can build an edge (e.g., a unidirectional edge or a bidirectional edge) between the two optimization tools, and eventually build a map that can navigate between different tools. For example, graph generation component 108 can navigate through the respective optimization tools and if an inter-relation exists between two optimization tools (e.g., one tool can take the outcome of another optimization tool), graph generation component 108 can build an edge or bridge between the two optimization tools. Each optimization tool can have a respective location on path finding graph 400, and respective optimization tools can be connected by respective paths to generate path finding graph 400, as illustrated in FIG. 4.

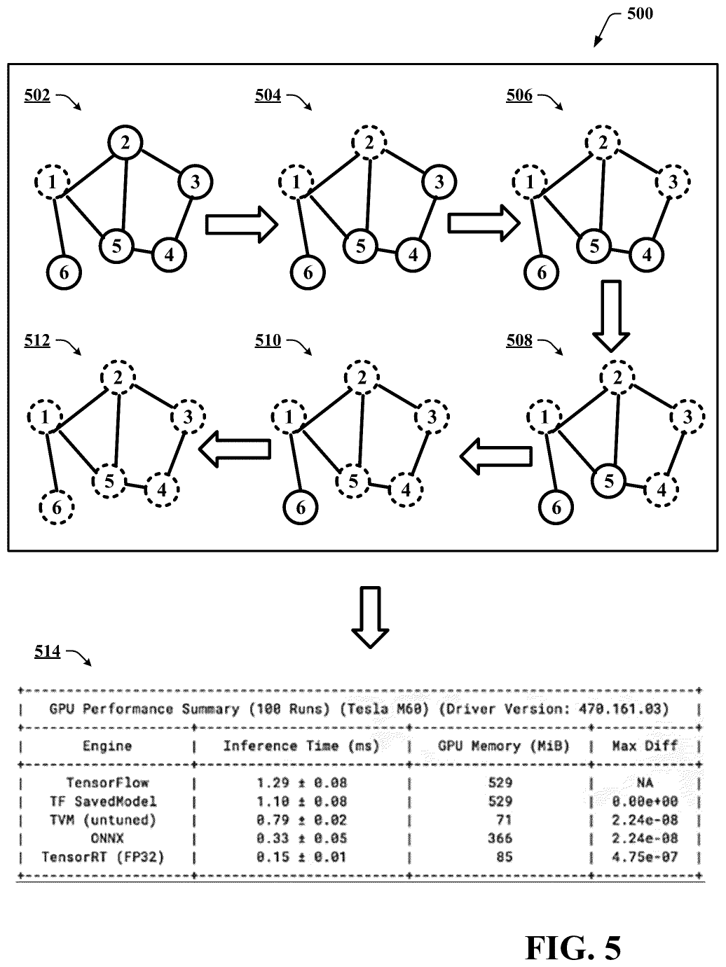

FIG. 5 illustrates a flow diagram of an example, non-limiting process 500 of graph solving employed by a path finding system for AI model optimization in accordance with one or more embodiments described herein. One or more embodiments discussed with reference to FIG. 5 can be performed by one or more components of system 100 of FIG. 1. Repetitive description of like elements and/or processes employed in respective embodiments is omitted for sake of brevity.

With continued reference to FIG. 1, in various embodiments, system 100 can employ path finding graph 116 to execute various workflows. For example, given a particular model optimization request, the workflow of system 100 (e.g., graph update component 110) can first prune unrelated optimization tools from path finding graph 116 based on specifications (e.g., OS, hardware, etc.). Next, system 100 can treat the remaining optimization tools in the graph system as nodes, and an optimization problem can be translated into a mathematical graph problem. Thereafter, system 100 can apply graph solver component 112 to solve the mathematical graph problem. Upon solving the mathematical graph problem, system 100 can apply AI model optimization component 114 to path finding graph 116 to find a solution to the optimization problem.

More specifically, upon generation of path finding graph 116, system 100 can employ path finding graph 116 to solve optimization problems such as making an AI model faster (e.g., making the AI model have greater inferencing speed) and more efficient in terms of resource consumption. For example, by employing path finding graph 116, optimization problems can be translated into graph problems that can be well-defined sets of problems. Thus, given the specification catalog and characteristics of various optimization tools, and given path finding graph 116, system 100 can translate an AI model optimization problem into a graph problem, and system 100 can solve the graph problem by using graph solver methods. Upon solving the graph problem, system 100 can translate the solution back to the AI optimization domain, and system 100 can being optimization of the AI model in a sequence, eventually achieving an optimization objective and summarizing results of the optimization.

System 100 can employ graph solver component 112 to traverse path finding graph 116 between nodes. A determination of an order in which graph solver component 112 can traverse path finding graph 116 can be based on a model optimization sequence, and the model optimization sequence can be relevant since certain nodes in path finding graph 116 can only be connected through one or more other nodes. In other words, using the model optimization sequence, graph solver component 112 can determine the correct order of travelling through path finding graph 116. For example, graph solver component 112 can begin traversing path finding graph 116 from node 1 (illustrated in the dashed circle at 502), wherein path finding graph 116 can comprise several nodes (i.e., optimization tools) that can be connected to node 1. From node 1, graph solver component 112 can traverse to node 2 (illustrated in the dashed circle at 504), for example, instead of traversing to node 5. From node 2, graph solver component 112 can traverse to node 3 (illustrated in the dashed circle at 506), from node 3, graph solver component 112 can traverse to node 4 (illustrated in the dashed circle at 508), from node 4, graph solver component 112 can traverse to node 5 (illustrated in the dashed circle at 510), and from node 5, graph solver component 112 can traverse to node 6 (illustrated in the dashed circle at 512) based on a model optimization sequence.

At each node that graph solver component 112 can traverse to, system 100 can employ AI model optimization component 114 to solve the optimization problem (e.g., optimize an AI model) using an optimization tool forming the node of path finding graph 116. It is to be appreciated that graph solver component 112 does not know ahead of time which node is the best to traverse to, from a particular node. Graph solver component 112 can travel to each node in path finding graph 116 and at each node, system 100 can benchmark an inferencing speed of the AI model optimized by AI model optimization component 114 using the optimization tool forming a respective node. For example, system 100 can traverse path finding graph 116 and visit all nodes that an original optimization tool (e.g., starting point in path finding graph 116 associated with an AI model to be optimized) can be connected to, and system 100 can systematically benchmark results of optimizing the AI model at respective nodes, followed by presenting the results in a table, such as table 514. For example, table 514 can illustrate respective inference times and GPU memory usage values for an AI model optimized using a TensorFlow™ model, a TensorFlow™ (TF) SavedModel (i.e., a format in TensorFlow™), TVM™, ONNX and TensorRT™. Table 514 can further illustrate that TensorRT™ offers the fastest inferencing speed among all the other options explored by graph solver component 112. In various embodiments, results generated by system 100 can also include information about a maximum absolute difference (listed as “Max Diff” values in table 514 and in results illustrated in subsequent figures) between a prediction of an original AI model and a prediction of an optimized AI model (e.g., generated after optimizing the original AI model). In table 514 (and in results illustrated in subsequent figures), respective “Max Diff” values correspond to respective optimization tools listed under the column “Engine.” Often, depending on the application, different thresholds for the maximum absolute difference can be defined, and the value of the maximum absolute difference can be different for different scenarios (e.g., as opposed to being a specific number that can apply to all scenarios). Thus, based on the model optimization sequence, graph solver component 112 can traverse path finding graph 116. As described elsewhere herein, connectivity of nodes and rules can be considered by graph solver component 112 for traversing path finding graph 116.

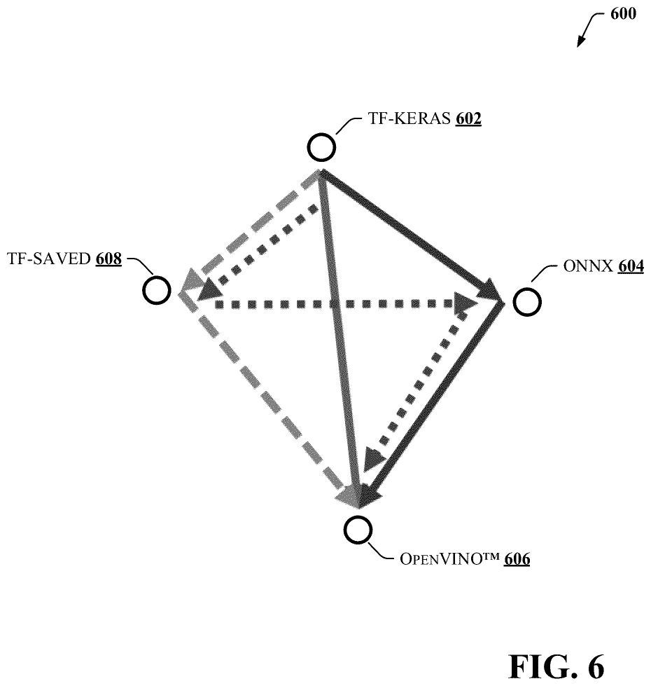

FIG. 6 illustrates a diagram of an example, non-limiting path finding graph 600 employed for multipath model optimization in accordance with one or more embodiments described herein. One or more embodiments discussed with reference to FIG. 6 can be performed by one or more components of system 100 of FIG. 1. Repetitive description of like elements and/or processes employed in respective embodiments is omitted for sake of brevity.

With continued reference to FIG. 1, in various embodiments, system 100 can build path finding graph 116. Path finding graph 600 can be an example of path finding graph 116 that can be built by system 100, and system 100 can employ path finding graph 600 to execute a multipath model optimization workflow. For example, system 100 can employ AI model optimization component 114 to optimize an AI model using path finding graph 116 based on an optimization requirement provided by a user. In various embodiments, the multipath model optimization workflow can solve a specific target optimization problem (e.g., AI model optimization problem) by finding all viable paths from one optimization tool to another in the path finding graph in an automatic and robust way. For example, optimization tools, TF Keras 602 and OpenVINO™ 606, can form nodes of path finding graph 600, and there can be multiple paths for traversing path finding graph 600 from TF Keras 602 to OpenVINO™ 606. For example, the solid arrows can indicate respective paths from TF Keras 602 directly to OpenVINO™ 606 (e.g., TF Keras→OpenVINO™), and from TF Keras 602 to OpenVINO™ 606 through ONNX 604 (e.g., TF Keras→ONNX→OpenVINO™). Further, the dashed arrows can indicate a path from TF Keras 602 to OpenVINO™ 606 through TF Saved 608 (e.g., TF Keras→TF-Saved→OpenVINO™), and the dotted arrows can indicate a path from TF Keras 602 to OpenVINO™ 606 through TF Saved 608 and ONNX 604 (e.g., TF Keras→TF-Saved→ONNX→OpenVINO™). Graph solver component 112 can identify potential paths from TF Keras 602 to OpenVINO™ 606, and graph solver component 112 can traverse the potential paths in a systematic way (e.g., based on connectivity and rules).

Optimization based on a specific target can imply that a user can provide an AI model in any format to system 100, for optimizing the AI model to a specific target framework, while conditioning the AI model on inferencing deployment constraints. For example, given a TensorFlow™ model, a user can aim to optimize (e.g., using system 100) the TensorFlow™ model to an OpenVINO™ model such that the TensorFlow™ model can run on the CPU of a Linux® machine. The multipath model optimization workflow can involve initializing path finding graph 116, followed by node pruning based on constraints, solving the path finding graph and executing optimizations for solving the target optimization problem. As stated elsewhere herein, node pruning can be performed when, for certain characteristics of an AI model to be optimized, certain nodes of path finding graph 116 can be irrelevant. For example, ONNX only works on a CPU. Thus, if a user desires to optimize an AI model to a GPU, graph update component 110 can prune ONNX out of path finding graph 116, such that any operations going through ONNX will not be displayed to the user. After optimizing an AI model at one node (e.g., using an optimization tool at that node), AI model optimization component 114 can move to another node.

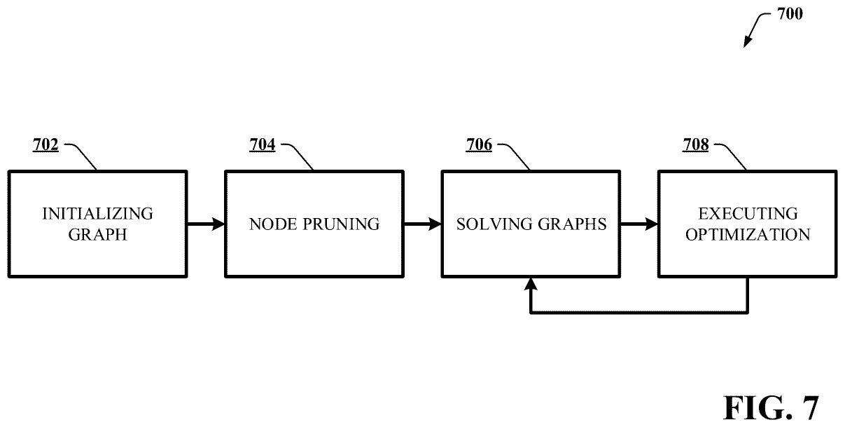

FIG. 7 illustrates a flow diagram of an example, non-limiting method 700 for multipath model optimization using a path finding system in accordance with one or more embodiments described herein. One or more embodiments discussed with reference to FIG. 7 can be performed by one or more components of system 100 of FIG. 1. Repetitive description of like elements and/or processes employed in respective embodiments is omitted for sake of brevity.

With continued reference to FIG. 6, non-limiting method 700 can represent the multipath model optimization workflow. At 702, non-limiting method 700 can comprise initializing path finding graph 116. At 704, non-limiting method 700 can comprise pruning of nodes from path finding graph 116 (e.g., by graph update component 110) based on constraints. As discussed earlier, node pruning can occur when, for certain characteristics of an AI model to be optimized, certain nodes of path finding graph 116 are determined as being irrelevant. At 706, non-limiting method 700 can comprise solving (e.g., by graph solver component 112) path finding graph 116. For example, path finding graph 116 (i.e., the updated path finding graph 116) can be solved to identify potential optimization options from a starting node of path finding graph 116. At 708, non-limiting method 700 can comprise executing optimizations on an AI model. For example, non-limiting method 700 can traverse from the starting node (e.g., first node) to another node (e.g., second node) in path finding graph 116 based on a model optimization sequence and optimize an AI model at the other node. The method loop illustrated between step 706 and step 708 of non-limiting method 700 can indicate that after optimizing an AI model at the other node, non-limiting method 700 can optimize the AI model at a different node until all nodes of path finding graph 116 have been traversed.

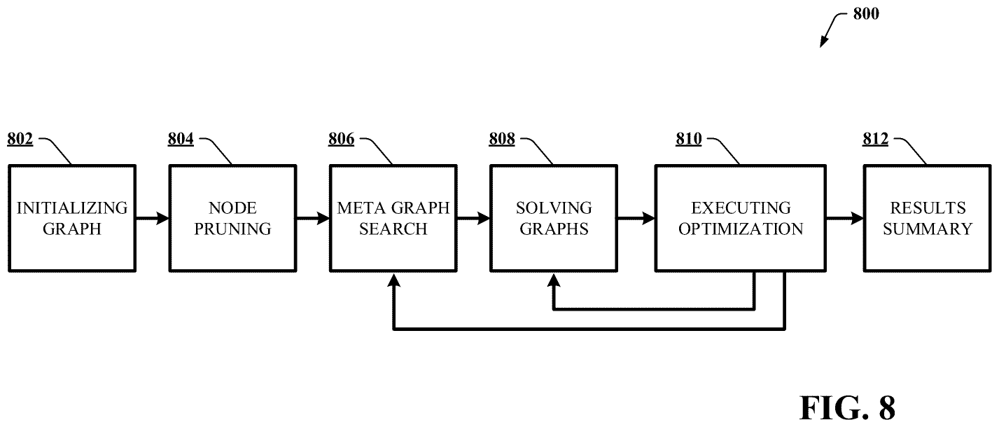

FIG. 8 illustrates a flow diagram of an example, non-limiting method for Spanning Tree model optimization using a path finding system in accordance with one or more embodiments described herein. One or more embodiments discussed with reference to FIG. 8 can be performed by one or more components of system 100 of FIG. 1. Repetitive description of like elements and/or processes employed in respective embodiments is omitted for sake of brevity.

With continued reference to FIG. 1, in various embodiments, AI model optimization component 114 can use path finding graph 116 to optimize the AI model, without the optimization requirement provided by the user, via a Spanning Tree model optimization workflow. In various embodiments, the Spanning Tree model optimization workflow can address open-ended AI optimization needs. The Spanning Tree model optimization workflow can operate by introducing a graph traversal workflow, known as meta graph search, in addition to the multipath model optimization workflow, wherein the meta graph search can search all non-repeated connected nodes through viable paths in path finding graph 116. For example, graph solver component 112 can loop through all possible connected paths in path finding graph 116 and perform a meta graph search, which can be a nested loop. Thus, the Spanning Tree model optimization workflow can be a generalization of the multipath model optimization workflow of a specific target.

Non-limiting method 800 can represent the Spanning Tree model optimization workflow. At 802, non-limiting method 800 can comprise, initializing path finding graph 116. At 804, non-limiting method 800 can comprise pruning of nodes from path finding graph 116 (e.g., by graph update component 110) based on constraints. As discussed earlier, node pruning can occur when, for certain characteristics of an AI model to be optimized, certain nodes of path finding graph 116 are determined as being irrelevant. At 806, non-limiting method 800 can comprise, performing a meta graph search, wherein non-repeated connected nodes of path finding graph 116 (i.e., the updated path finding graph 116) can be searched (e.g., by graph solver component 112) through viable paths in path finding graph 116. At 808, non-limiting method 800 can comprise solving (e.g., by graph solver component 112) path finding graph 116. For example, path finding graph 116 (i.e., the updated path finding graph 116) can be solved to identify potential optimization options from a starting node of path finding graph 116. At 810, non-limiting method 800 can comprise executing optimizations on an AI model. For example, non-limiting method 800 can traverse from the starting node (e.g., first node) to another node (e.g., second node) in path finding graph 116 based on a model optimization sequence and optimize an AI model at the other node. Non-limiting method 800 can comprise two method loops, as illustrated in FIG. 8. The outer loop between step 806 and step 810 can occur prior to the inner loop between step 806 and step 810, followed again by the outer loop. That is, the inner and outer method loops can occur in a sequence/be sequential. At 812, non-limiting method 800 can comprise generating a summary of results of optimizing an AI model at various nodes (e.g., optimization tools) of path finding graph 116.

The Spanning Tree model optimization workflow can address a scenario wherein a user can start from an AI model of any format without providing any specific optimization target. System 100 can then evaluate all viable nodes in path finding graph 116 that can be reached via connected paths under user-defined constraints. For example, a user can provide a PyTorch® model with the intention to evaluate all available optimization options for a NVIDIA® GPU with a maximum error less than 0.005. Such an optimization exploration can significantly reduce the expertise needed from an end user to perform model optimization because the Spanning Tree model optimization workflow can turn model optimization into a fully automated workflow and not require any prior knowledge about existence of model optimization frameworks or methods. Thus, the Spanning Tree model optimization workflow can allow users to explore (e.g., using system 100) various optimization solutions that can exist for optimizing an AI model, without requiring information about an optimization target from the user.

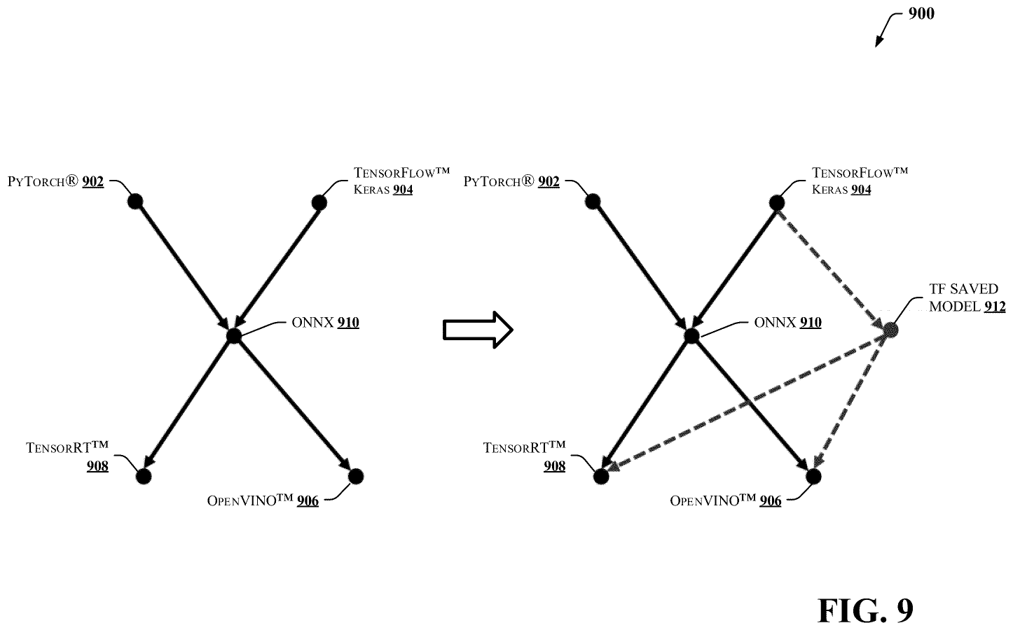

FIG. 9 illustrates a flow diagram of an example, non-limiting process 900 of inserting an optimization node in a path finding graph for AI model optimization in accordance with one or more embodiments described herein. One or more embodiments discussed with reference to FIG. 9 can be performed by one or more components of system 100 of FIG. 1. Repetitive description of like elements and/or processes employed in respective embodiments is omitted for sake of brevity.

With continued reference to FIG. 1, in various embodiments, graph update component 110 can update path finding graph 116 by executing an optimization node insertion/removal workflow. The optimization node insertion/removal workflow can comprise addition or removing one or more optimization tools to path finding graph 116 without performing a system-level redesign, thereby allowing system 100 to integrate new technologies or delete existing technologies from path finding graph 116, seamlessly. For example, a new optimization tool created by a company can become available in the market, and graph update component 110 can integrate the new optimization tool in path finding graph 116 (e.g., an existing path finding graph system) by drawing bridges between the new optimization tool and existing optimization tools in path finding graph 116, such that an existing overall design of path finding graph 116 can continue to operate without needing any changes. More specifically, from one node to another node in path finding graph 116, path finding graph 116 can continue to operate even after addition of the new optimization tool. Likewise, if a company responsible for an optimization tool that can be included in path finding graph 116 declares the optimization tool as no longer supported by the company, the optimization tool can be removed from path finding graph 116, and path finding graph 116 can continue to operate without requiring further changes.

For example, the graph illustrated at the left-hand side of process 900 can represent path finding graph 116, and path finding graph 116 can comprise optimization tools PyTorch® 902, TF Keras 904, ONNX 910, OpenVINO™ 906 and TensorRT™ 908. Graph update component 110 can add a new optimization tool, TF SavedModel 912, to path finding graph 116, by connecting TF SavedModel 912 and various optimization tools existing in path finding graph 116 through edges and updating path finding graph 116. The updated graph (e.g., the updated path finding graph 116) can be as illustrated at the right-hand side of process 900. The connections generated between TF SavedModel 912 and other optimization tools of path finding graph 116 are illustrated by the dashed arrows. To integrate a new optimization tool (e.g., TF SavedModel 912) into path finding graph 116, graph update component 110 can only need a node (e.g., the new optimization tool) to be registered to path finding graph 116 (according to characteristics of the new optimization tool in a standardized catalog, as described above). Thereafter, a corresponding conversion function can be added to capture relations (e.g., edges) between optimization nodes. Thus, the node insertion/removal workflow can offer a unique way of integrating or deleting optimization tools without requiring a system-level redesign.

Thus, in various embodiments, system 100 can enable seamless addition and/or removal of optimization tools (e.g., nodes). The node addition/removal can be performed at a program level at the end of a developer of system 100. As stated elsewhere herein, path finding graph 116 can be a data structure and new optimization tools can be added by graph update component 110 as nodes in the data structure, causing path finding graph 116 to be updated. The nodes of path finding graph 116 can be part of a node register.

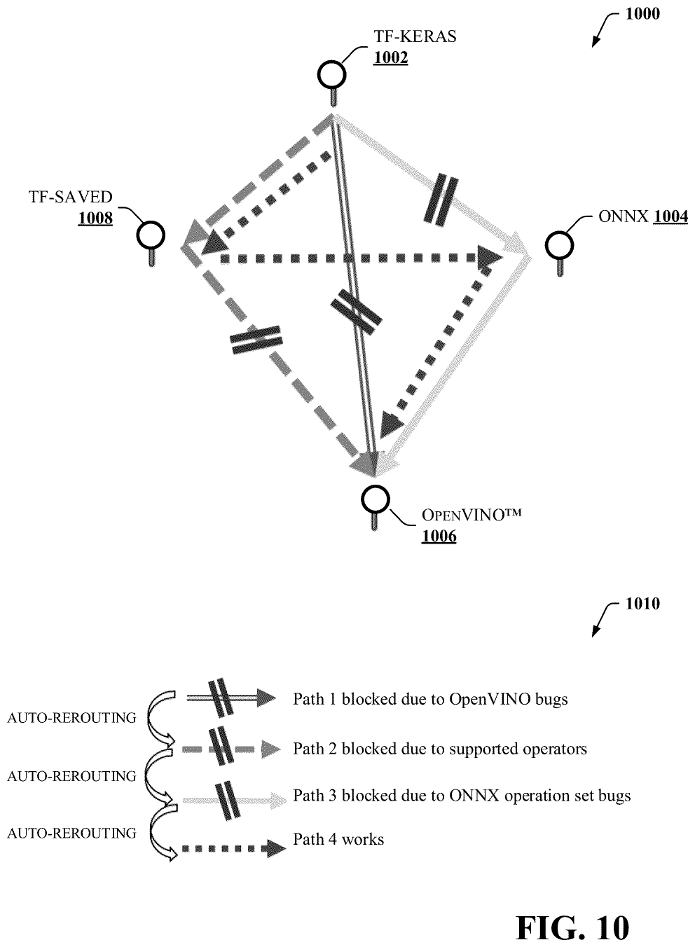

FIG. 10 illustrates a diagram of an example, non-limiting path finding graph 1000 for alternative path rerouting for optimization of an AI model in accordance with one or more embodiments described herein. One or more embodiments discussed with reference to FIG. 10 can be performed by one or more components of system 100 of FIG. 1. Repetitive description of like elements and/or processes employed in respective embodiments is omitted for sake of brevity.

With continued reference to FIG. 1, in various embodiments, graph solver component 112 can execute an alternative path rerouting workflow during optimizing of AI models. For example, graph solver component 112 can reroute from a first path to a second path in path finding graph 116, during traversal of path finding graph 116 for optimization of an AI model, to avoid bugs or errors in the first path. Alternative path rerouting can be an extension of the multipath model optimization workflow described in various embodiments. For example, as discussed with reference to the multipath model optimization workflow, path finding graph 116 can offer multiple routes from one optimization tool to another. In path finding graph 116, certain paths from a first optimization tool to a second optimization tool can become blocked due to bugs, errors, and/or unsupported use cases, etc. Bugs can be any human mistake made in a program, wherein the mistake can cause the program to not behave in an expected manner. In such a scenario, graph solver component 112 can traverse all paths from the first optimization tool to the second optimization tool to identify an error-free path between the first optimization tool and the second optimization tool. AI optimization being a highly evolving field wherein optimization tools can be under active development and upgrade by each vendor company, bugs can occur in paths of path finding graph 116. For example, bugs can prevent an operation of an AI model from optimizing, which can be equivalent to a mathematical operator being unsupported. In another example, new upgrades to a software can cause an operator to be inconsistent with an earlier model. That is, originally, the model can be capable of producing a certain result, however, after an upgrade, a bug can be introduced into the model, and the upgraded version of the model can produce a different result from the original result.

Path finding graph 1000 can be an example of path finding graph 116, and path finding graph 1000 can comprise optimization tools, TF Keras 1002, ONNX 1004, OpenVINO™ 1006 and TF Saved 1008. Path finding graph 1000 can further comprise bugs. In various embodiments, alternative path rerouting can be performed by graph solver component 112 to solve an optimization problem (e.g., to optimize an AI model) from TF Keras 1002 as a starting node to OpenVINO™ 1006. As indicated by legend 1010, path 1 (e.g., the path from TF Keras 1002 to OpenVINO™ 1006 illustrated by the double lined arrow) can be blocked due to OpenVINO™ bugs, and graph solver component 112 can auto-reroute to path 2 (e.g., the path illustrated by the dashed arrows). Path 2 can be blocked due to unsupported operators, and graph solver component 112 can auto-reroute to path 3 (e.g., the path illustrated by the solid lined arrows). Path 3 can be blocked due to ONNX operation set bugs, and graph solver component 112 can auto-reroute to path 4 (e.g., the path illustrated by the dotted arrows). Path 4 can be free from any errors, bugs and/or unsupported use cases, and graph solver component 112 can traverse path finding graph 116 along path 4.

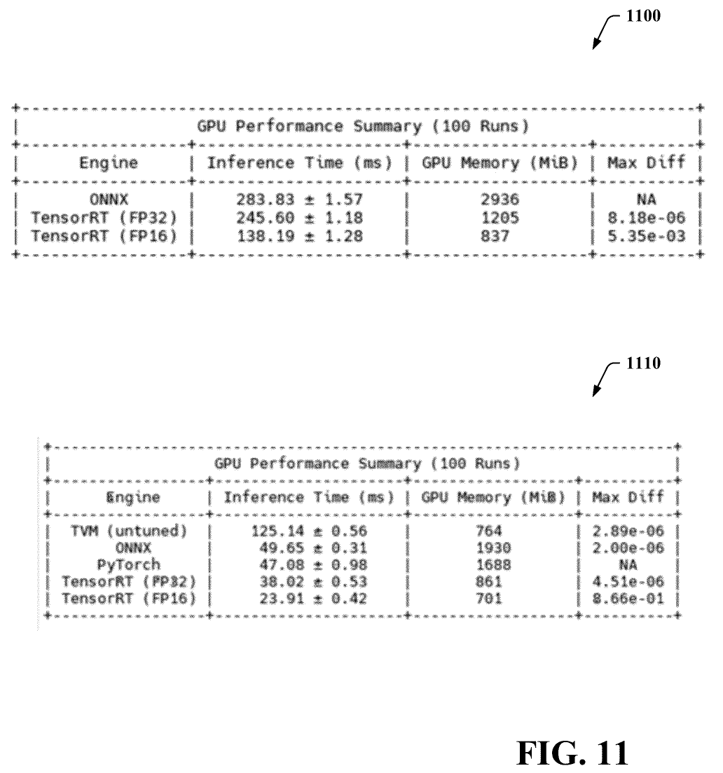

FIG. 11 illustrates example, non-limiting results 1100 and 1110 generated by a path finding system by employing a path finding graph to optimize AI models developed for the X-Ray domain in accordance with one or more embodiments described herein. One or more embodiments discussed with reference to FIG. 11 can be performed by one or more components of system 100 of FIG. 1. Repetitive description of like elements and/or processes employed in respective embodiments is omitted for sake of brevity.

In various embodiments, a path finding system (e.g., system 100) can capture inter-relations between different optimization tools by translating a model optimization workflow into a mathematical graph system, that can provide a systematic approach for coordinating the different optimization tools and significantly reduce the time and expertise needed for performing model optimization. The path finding system can also provide a flexibility of adding or removing optimization tools, such that a new technology can be incorporated without requiring additional redesign of an existing system. The graph-based approach can offer multiple paths for achieving AI model optimization by graph traversal, effectively reducing a risk of AI deployment caused by specific bugs or unsupported operations.

Results 1100 and 1110 are based on testing of the path finding system on various AI models (developed by General Electric (GE) HealthCare) for the X-Ray modality and display a GPU performance summary over 100 runs. Results 1100 correspond to optimizing an X-Ray NGTube AI model using the path finding system and results 1110 correspond to optimizing an X-Ray AITE model. The X-Ray NGTube model is a segmentation model that can point out areas of interest for radiologists to improve their diagnosis workflow and the X-Ray AITE is an image enhancement model that can enhance medical images. Medical images acquired by a modality (e.g., computed tomography (CT), MRI, etc.) need to undergo image processing to enhance visibility of the medical images, and the X-Ray AITE model is an AI model that can perform such image enhancement. It was observed that the X-Ray AITE model can be optimized to have a faster inferencing speed than the original model.

Results 1100 can indicate that optimizing the X-Ray NGTube model with an ONNX optimization tool can provide the fastest inferencing time (e.g., 283.83±1.57 milliseconds (ms)), and optimizing the X-Ray NGTube model with a TensorRT™ (FP16) can cause the X-Ray NGTube model to have the least amount of GPU memory usage (837 mebibyte (MiB)) when performing an inferencing task, as compared to other optimization tools. Similarly, results 1110 can indicate that optimizing the X-Ray AITE model with a TVM™ (untuned) optimization tool can provide the fastest inferencing time (e.g., 125.14±0.56 ms), and optimizing the X-Ray NGTube model with a TensorRT™ (FP16) can cause the X-Ray AITE model to have the least amount of GPU memory usage (701 MiB) when performing an inferencing task, as compared to other optimization tools. Thus, the path finding system disclosed in various embodiments, can generate results that can show a performance summary based on optimizing an AI model with different optimization tools.

Table 1 and Table 2 below display results generated by the pathfinding system for optimizing other AI models with different optimization tools. In various embodiments, the path finding system can be integrated into a tool. For example, the path finding system can be integrated into AI tools that companies can leverage.

TABLE 1

| Framework | GPU time/Memory |
|---|---|
| TensorFlow ™ | Not counted, too big |
| ONNX | 290 ms/2938 MB |
| Tensor Visual Machine | 570 ms/1158 MB |
| TensorRT ™ (32 bit) | 247 ms/1211 MB |
| TensorRT ™ (16 bit) | 137 ms/838 MB (error = 2%) |

TABLE 2

| Framework | CPU time | |
|---|---|---|
| TensorFlow ™ | >4 | sec. |
| ONNX | ~3.2 | sec. |
| OpenVINO ™ (32 bit) | ~3.0 | sec. |

| | |
|---|---|
| OpenVINO ™ | Faster but high errors |

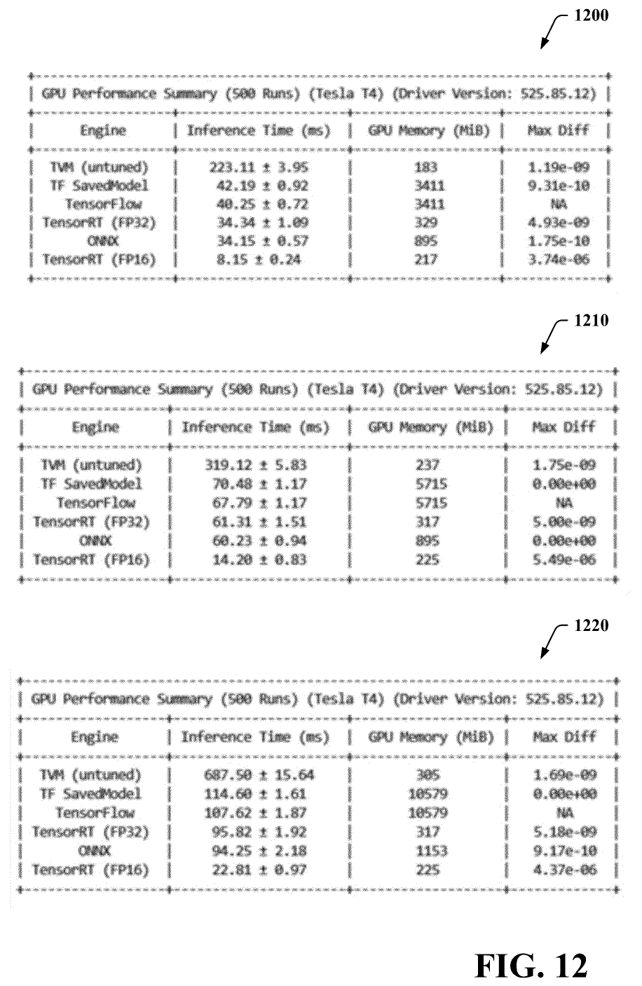

FIG. 12 illustrates example, non-limiting results 1200, 1210 and 1220 generated by a path finding system by employing a path finding graph to optimize AI models developed for the MRI domain in accordance with one or more embodiments described herein. One or more embodiments discussed with reference to FIG. 12 can be performed by one or more components of system 100 of FIG. 1. Repetitive description of like elements and/or processes employed in respective embodiments is omitted for sake of brevity.

In various embodiments, a path finding system (e.g., system 100) can capture inter-relations between different optimization tools by translating a model optimization workflow into a mathematical graph system that can provide a systematic approach for coordinating the different optimization tools and significantly reducing the time and expertise needed for performing model optimization. The path finding system can also provide a flexibility of adding or removing optimization tools, such that a new technology can be incorporated without requiring additional redesign of an existing system. The graph-based approach can offer multiple paths for achieving AI model optimization by graph traversal, effectively reducing a risk of AI deployment caused by specific bugs or unsupported operations.

Results 1200, 1210 and 1220 are based on testing of the path finding system on an AI model for the MRI modality on an NVIDIA® T4 GPU and Linux® OS, wherein the AI model can be used in a three-dimensional (3D) image reconstruction algorithm. Results 1200, 1210 and 1220 display a GPU performance summary over 500 runs and identify respective OS driver versions. Further, results 1200, 1210 and 1220 provide benchmarking of optimizing the AI model for different image sizes. For example, results 1200 correspond to a slice size of 300*300, results 1210 correspond to a slice size of 400*400 and results 1220 correspond to a slice size of 500*500.

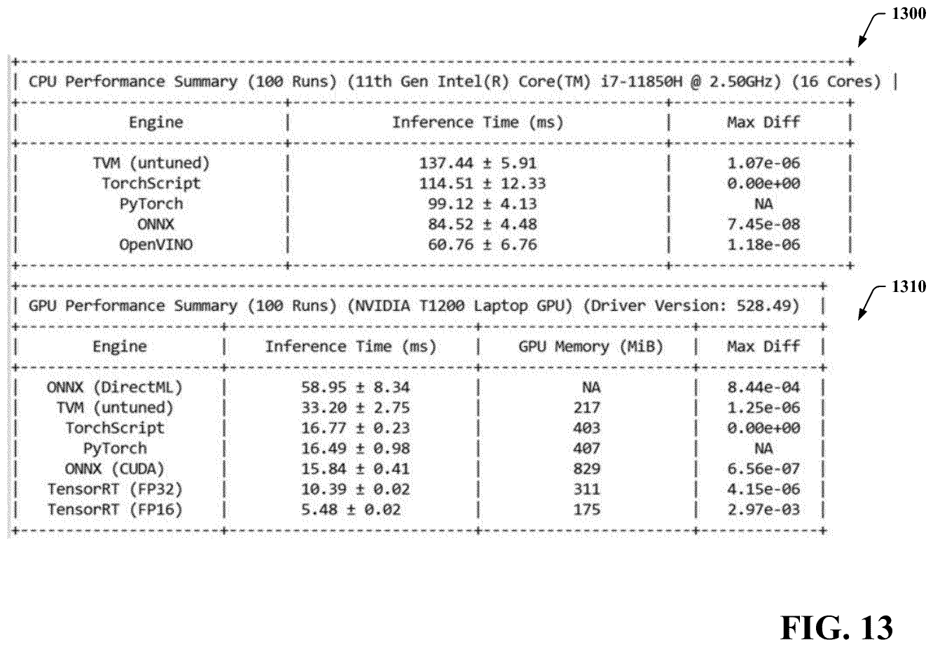

FIG. 13 illustrates example, non-limiting results 1300 and 1310 generated by a path finding system by employing a path finding graph to optimize an AI model developed for image segmentation in accordance with one or more embodiments described herein. One or more embodiments discussed with reference to FIG. 13 can be performed by one or more components of system 100 of FIG. 1. Repetitive description of like elements and/or processes employed in respective embodiments is omitted for sake of brevity.

In various embodiments, a path finding system (e.g., system 100) can capture inter-relations between different optimization tools by translating a model optimization workflow into a mathematical graph system, that can provide a systematic approach for coordinating the different optimization tools and significantly reducing the time and expertise needed for performing model optimization. The path finding system can also provide a flexibility of adding or removing optimization tools, such that a new technology can be incorporated without requiring additional redesign of an existing system. The graph-based approach can offer multiple paths for achieving AI model optimization by graph traversal, effectively reducing a risk of AI deployment caused by specific bugs or unsupported operations.

Results 1300 and 1310 are based on testing of the path finding system on a Unet model on a Windows system. Results 1300 and 1310 display similar categories of information as seen in results illustrated in FIGS. 11 and 12, and results 1300 and 1310 can indicate that the path finding system can be versatile enough to handle various types of AI models based on various system configurations, such that the path finding system can be employed for different AI models. Further, Table 3 below displays benchmarks generated by the path finding system on different hardware specifications and a comparison of the benchmarks with an evaluation of the OctoML® framework. In Table 3, PC can represent a PC specification of AMD threadripper 1900X 8core, GTX1080ti.

TABLE 3

| | Resnet50 Inferencing time in ms, batch = 1, float32, input (224, 224, 3), output(1000) | | | | | | |
|---|---|---|---|---|---|---|---|
| | | CPU | | | GPU | | |
| | Options | P2.xlarge | P3.2xlarge | PC* | P2.xlarge | P3.2xlarge | PC* |
| Path | TF Keras | 97.76 | 63.18 | 59.48 | 19.77 | 6.71 | 7.69 |
| finding | OpenVINO ™/ | 62.10 | 35.38 | 24.58 | 11.33 | 2.12 | 3.41 |
| system | Tensor RT ™ | | | | | | |
| | TVM ™ | 153.92 | 73.63 | 48.37 | 11.13 | 2.52 | 2.97 |
| | (untuned) | | | | | | |
| | TVM ™ Tuning | 76.59 | 40.31 | 28.73 | 10.12 | 2.31 | 2.94 |

| | |
|---|---|
| OctoML ® | 81.38 |

In experiments conducted for evaluating performance of the path finding system, comparisons of the path finding system against OctoML® were performed in terms of both, optimization workflows and speed benchmarks. Although OctoML® offers an AI model optimization product, an extensive evaluation of OctoML® followed by benchmarking results revealed that the path finding system holds various advantages over OctoML®. For example, the path finding system can offer ease of scalability, and because of the more extensive scope supported by the path finding system, the various embodiments discussed herein can cover more optimization space for the same compute resources, thereby attaining faster models. Contrarily, OctoML® does not offer multiple path optimization (e.g., multipath optimization workflow) or a path rerouting mechanism (e.g., alternative path rerouting workflow), as a result of which, an optimization problem that worked on the path finding system failed in OctoML® due to bugs encountered during evaluation. This can indicate that the path finding system can offer a better system stability (e.g., as compared to OctoML®) that can be more suitable for the fast-evolving nature of AI model optimization.

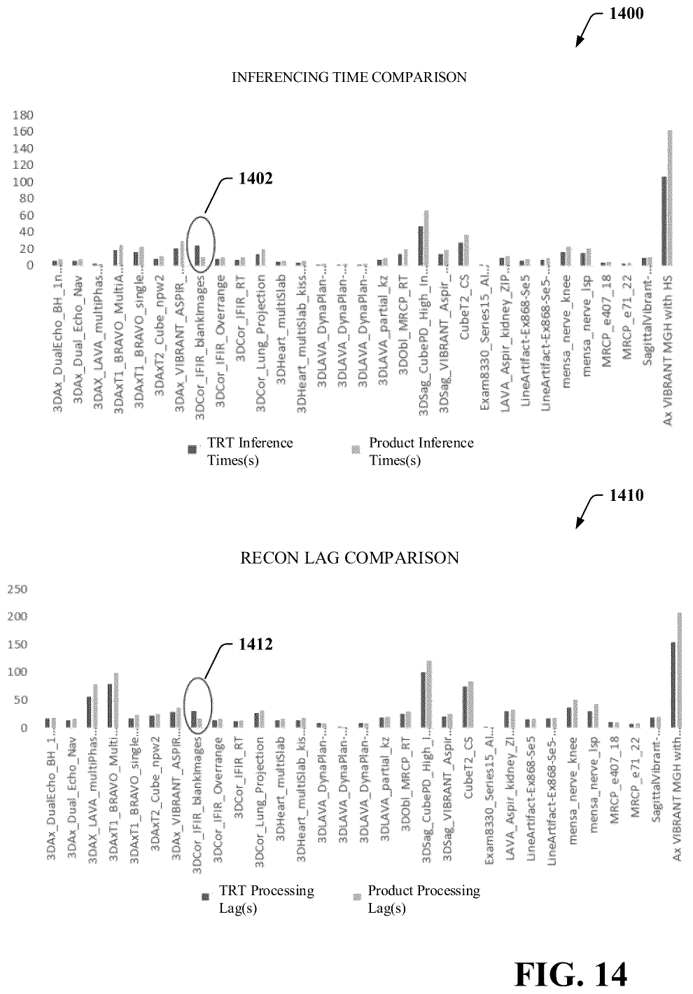

FIG. 14 illustrates example, non-limiting graphs 1400 and 1410 of inference times and recon lag results comparisons for an AI model before and after optimization of the AI model in accordance with one or more embodiments described herein. One or more embodiments discussed with reference to FIG. 14 can be performed by one or more components of system 100 of FIG. 1. Repetitive description of like elements and/or processes employed in respective embodiments is omitted for sake of brevity.

FIG. 14 illustrates additional results of testing the path finding system. A measure for various MRI images was experimentally determined using the path finding system to observe inferencing time reductions that can be obtained for an AI model (MR Recon3D model) by the path finding system. Graph 1400 illustrates a comparison of inferencing times of the AI model before and after optimization of the AI model by the path finding system, and graph 1410 illustrates a comparison of recon lag of the AI model before and after optimization of the AI model by the path finding system. In FIG. 14, TRT stands for TensorRT™, indicating that the path finding system selected TensorRT™ as the fastest inferencing solution for the particular optimization illustrated in FIG. 14. The horizontal axes in graphs 1400 and 1410 correspond to different MRI images listed along the horizontal axes.

Graphs 1400 and 1410 illustrate that shorter inferencing times were observed upon optimizing the AI model using the path finding system. The inference times of the AI model optimized with the path finding system were shorter by up to 30 percent (%), that is, an AI operation speed or time needed by the AI model was reduced by 30% upon optimization of the AI model with the path finding system. Further, almost all 3D harmonizer data had shorter inferencing times and recon lag (up to ˜30% time reduction). Graphs 1400 and 1410 further illustrate that a higher resolution of images can lead to a more significant performance gain from the path finding system. Except for the cases illustrated at 1402 and 1404, all other MRI images displayed up to a 30% reduction in inferencing times, however, performance of the data for the cases at 1402 and 1412 can be remeasured.

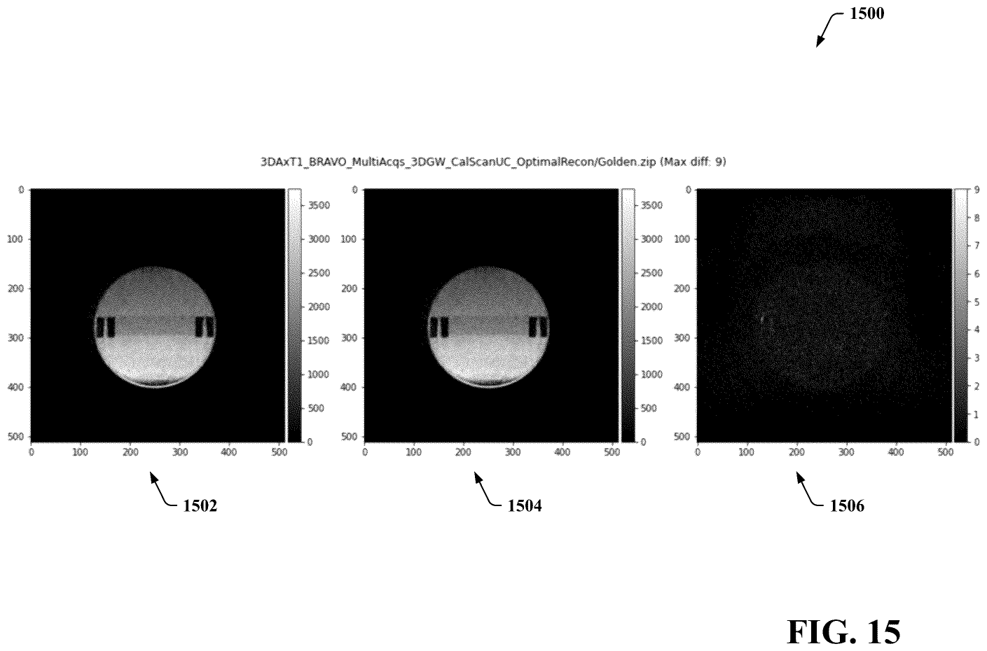

FIGS. 15-19 illustrate example, non-limiting images generated by respective AI models before and after optimization of the respective AI models in accordance with one or more embodiments described herein. Repetitive description of like elements and/or processes employed in respective embodiments is omitted for sake of brevity.

With continued reference to FIG. 14, an image quality (IQ) comparison of MRI images generated by the AI model, before and after optimization of the AI model with the path finding system, was performed to observe differences in visibility of the images (e.g., how much of a difference in IQ can be seen by a radiologist). A “max diff” of the recon score card was 2. As stated elsewhere herein, “max diff” can represent a maximum absolute difference between a prediction of an original AI model and a prediction of an optimized AI model. Often, depending on the application, different thresholds for “max diff” can be defined. Therefore, the value of the maximum absolute difference can be different for different scenarios (e.g., as opposed to being a specific number that can apply to all scenarios). Among 25 harmonizer datasets, most of the IQ difference was found to be within single digits except for the following datasets with an intensity correction or an intensity filter:
3DAx_Dual_Echo_Nav (max diff 106), PURE1 on
3DCor_IFIR_Overrange(max diff 18), clariviewfilter E on
3DCor_Lung_Projection (max diff 19): original image max diff 2
LineArtifact-Ex8680Se5 (max diff 13), PURE2 on
LineArtifact-Ex8680Se5-phasePadding (max diff 13), PURE2 on
MRCP_e71_22(max diff 67), PURE1 on

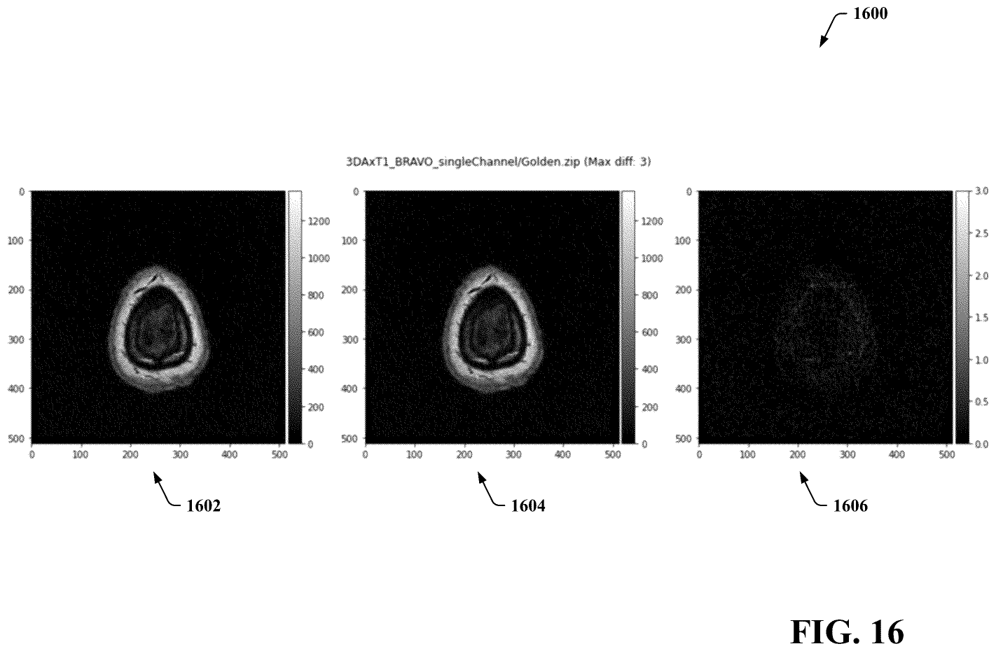

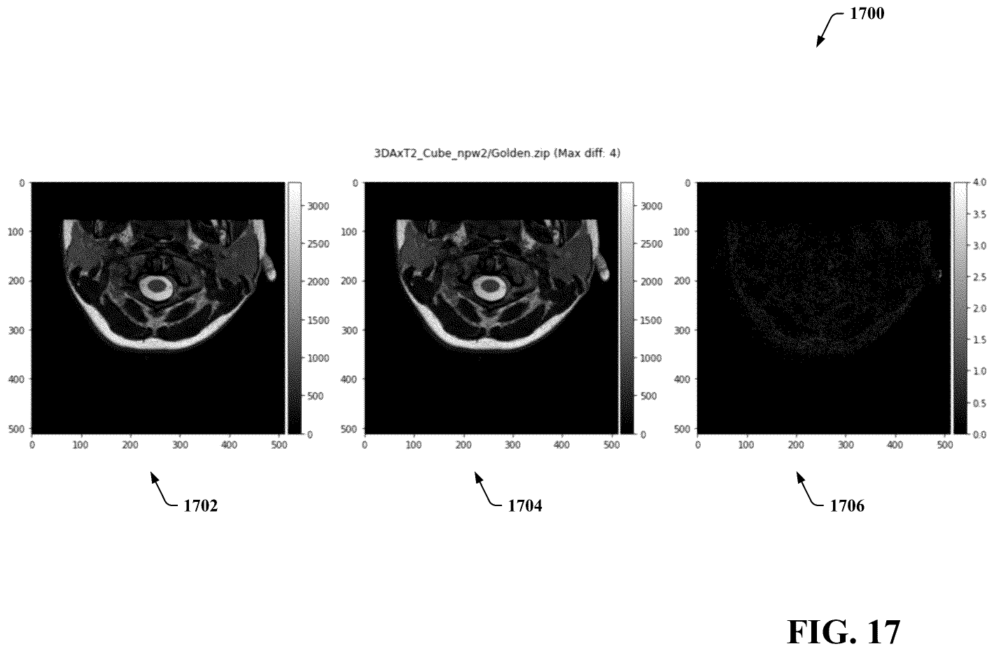

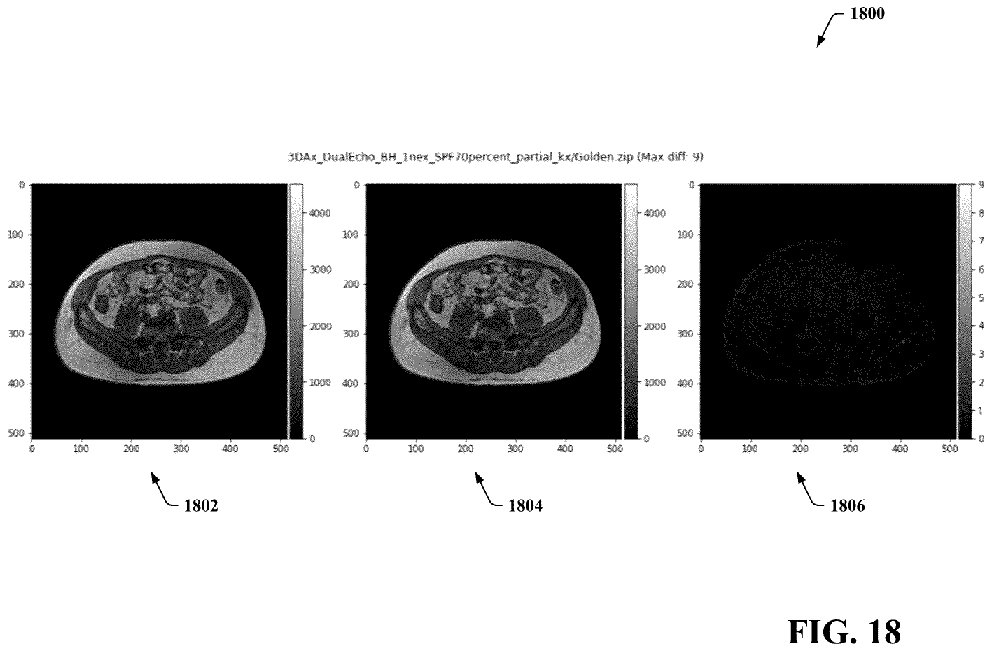

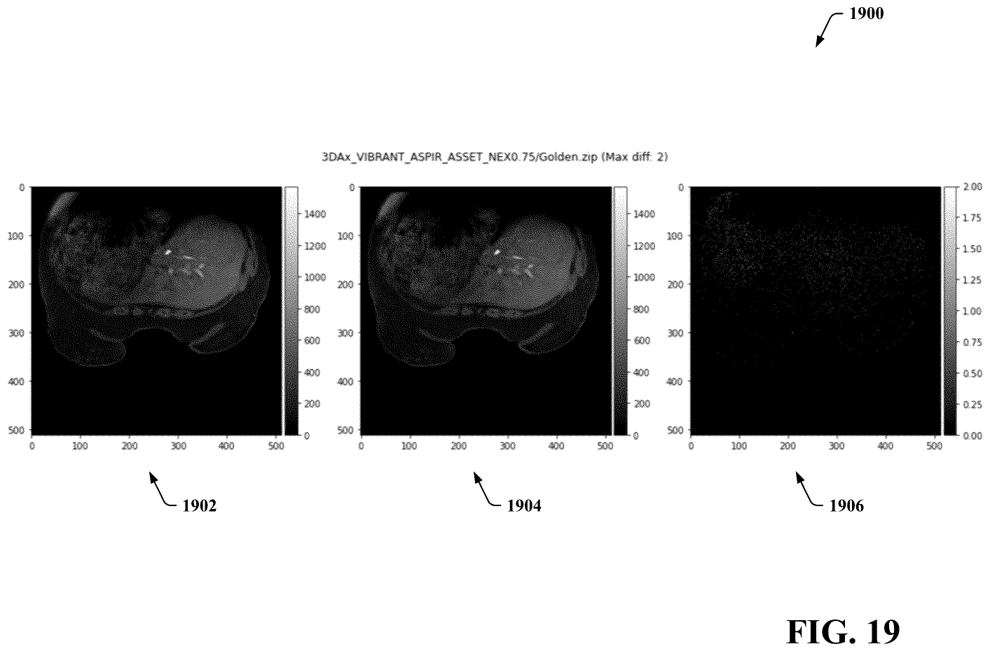

FIGS. 15-19 illustrate the IQ comparison of the MRI images generated by the AI model before and after optimization of the AI model by the path finding system. In each of FIGS. 15-19, the leftmost image is an image generated by the original AI model, the middle image is an image generated by the AI model after optimization of the original AI model by the path finding system, and the rightmost image is a difference/delta of the leftmost image and the middle image. Thus, at 1500 in FIG. 15, image 1502 is an image generated by the original AI model, image 1504 is an image generated by the AI model after optimization of the original AI model by the path finding system, and image 1506 is a difference/delta of image 1502 and image 1504. Similarly, at 1600 in FIG. 16, image 1602 is an image generated by the original AI model, image 1604 is an image generated by the AI model after optimization of the original AI model by the path finding system, and image 1606 is a difference/delta of image 1602 and image 1604. Similarly, at 1700 in FIG. 17, image 1702 is an image generated by the original AI model, image 1704 is an image generated by the AI model after optimization of the original AI model by the path finding system, and image 1706 is a difference/delta of image 1702 and image 1704. Similarly, at 1800 in FIG. 18, image 1802 is an image generated by the original AI model, image 1804 is an image generated by the AI model after optimization of the original AI model by the path finding system, and image 1806 is a difference/delta of image 1802 and image 1804. Similarly, at 1900 in FIG. 19, image 1902 is an image generated by the original AI model, image 1904 is an image generated by the AI model after optimization of the original AI model by the path finding system, and image 1906 is a difference/delta of image 1902 and image 1904. It can be evident from each of FIGS. 15-19, that the difference in the images (e.g., before and after optimization of an AI model) can be non-existent from a human visibility perspective.

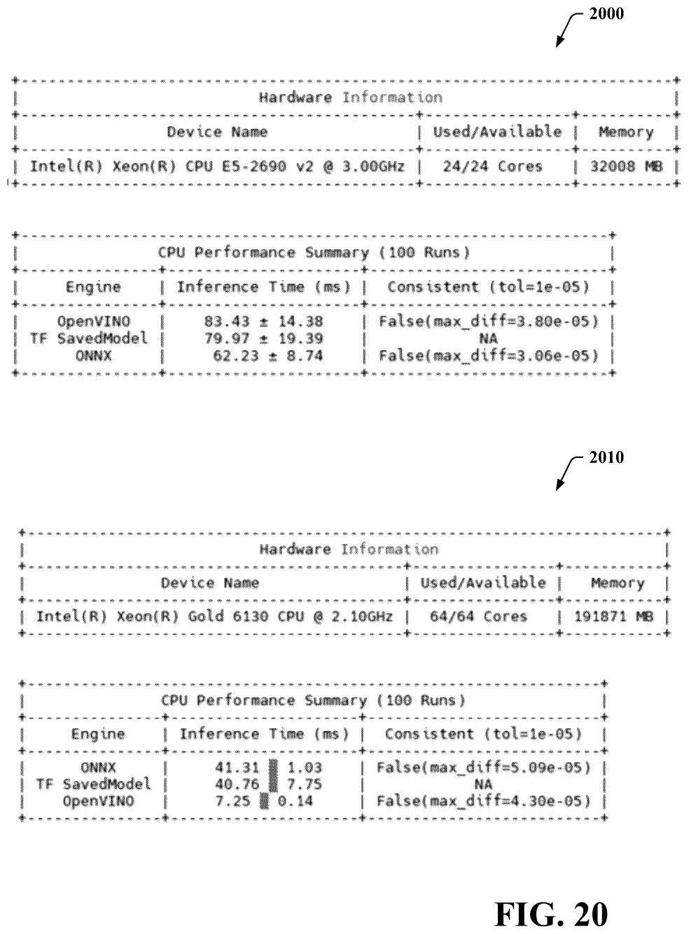

FIGS. 20-25 illustrates example, non-limiting results generated by a path finding system by employing a path finding graph to optimize respective AI models on VMs and actual hardware in accordance with one or more embodiments described herein. Repetitive description of like elements and/or processes employed in respective embodiments is omitted for sake of brevity.

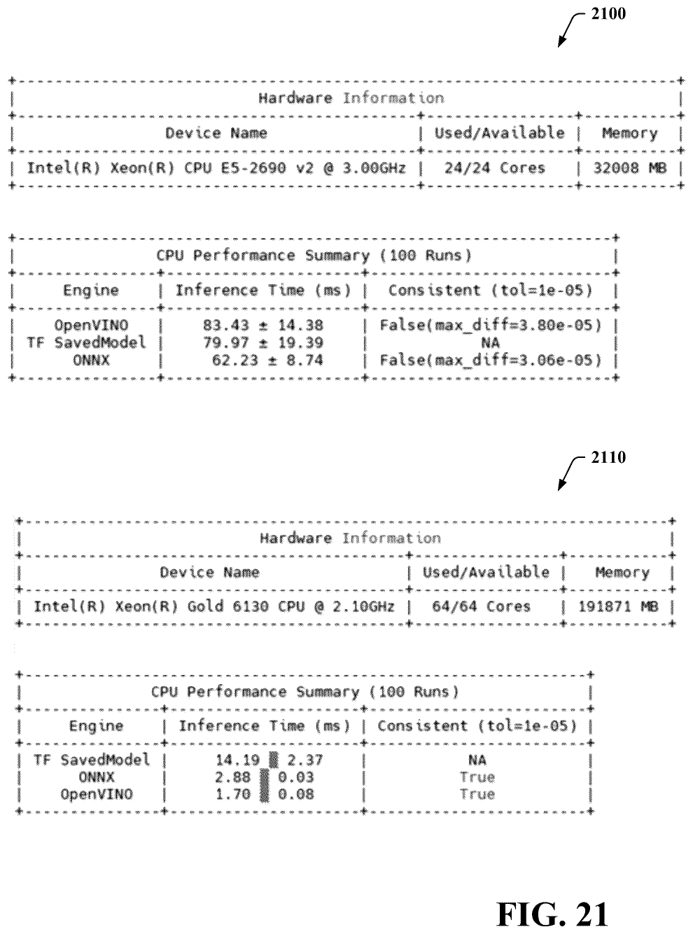

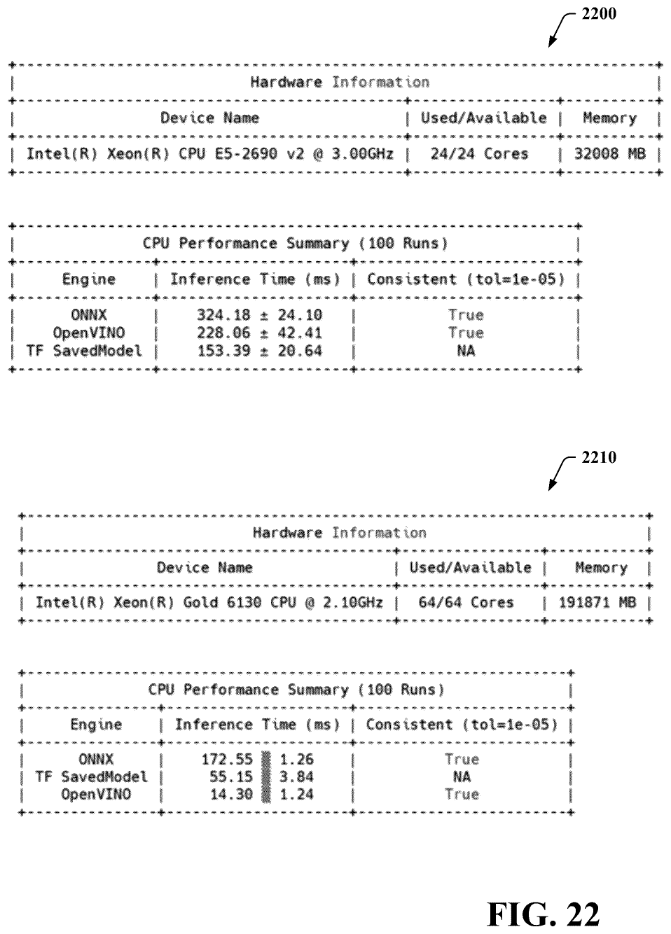

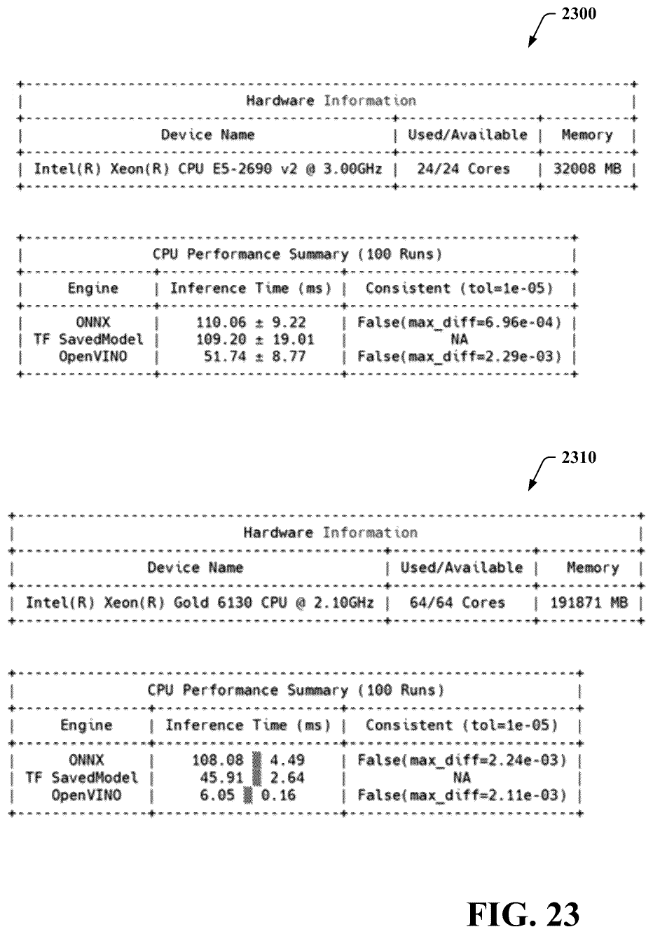

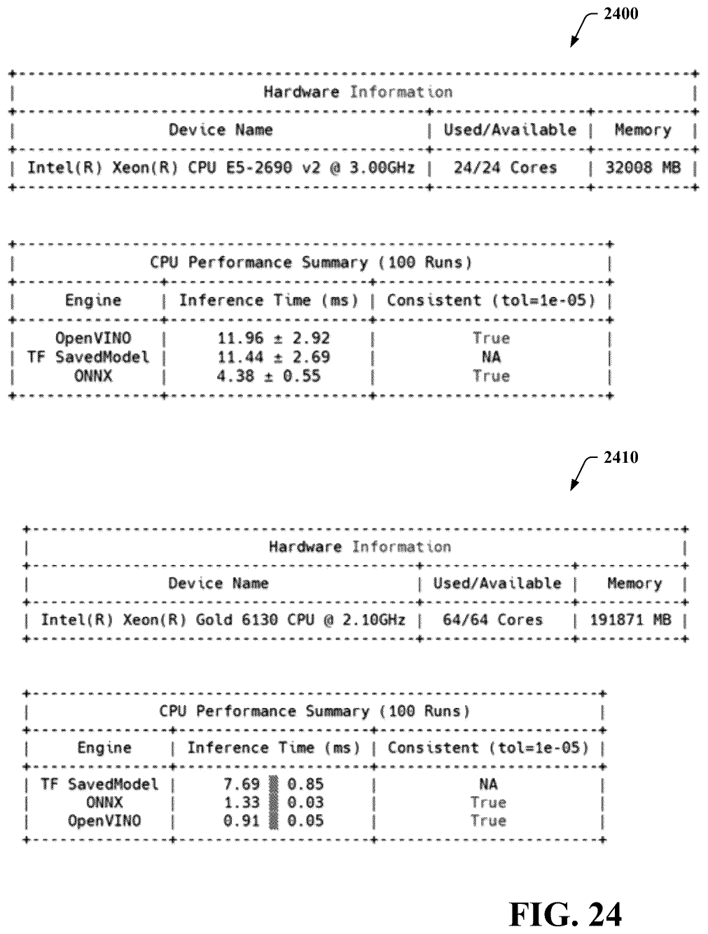

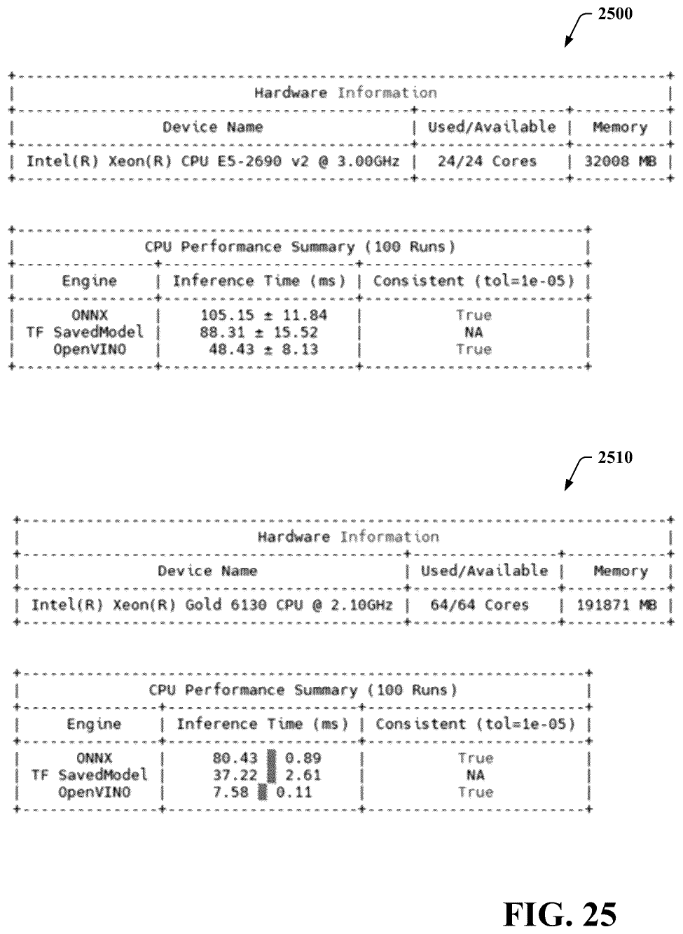

FIGS. 20-25 illustrate results summarized by the path finding system by optimization of AI models using the path finding system, wherein the AI models were segmentation models that can perform segmentation of different areas within different MRI images for different landmarks. The AI models considered in this section were products of MR airX, a division of GE HealthCare. In each of FIGS. 20-25, the results presented in the upper portion of a figure correspond to testing the path finding system on a virtual machine (VM) and the results presented in the bottom portion of the figure correspond to testing the path finding system on an actual product hardware (namely, VRE) used by an MRI machine. In FIG. 20, results 2000 correspond to testing the path finding system on a VM and results 2010 correspond to testing the path finding system on a VRE for optimizing a coverage NetBrain model. In FIG. 21, results 2100 correspond to testing the path finding system on a VM and results 2110 correspond to testing the path finding system on a VRE for optimizing a Localizerlq brain model. In FIG. 22, results 2200 correspond to testing the path finding system on a VM and results 2210 correspond to testing the path finding system on a VRE for optimizing a SPN brain model. In FIG. 23, results 2300 correspond to testing the path finding system on a VM and results 2310 correspond to testing the path finding system on a VRE for optimizing a coverage_net_knee model. In FIG. 24, results 2400 correspond to testing the path finding system on a VM and results 2410 correspond to testing the path finding system on a VRE for optimizing a Localizer_iq knee model. In FIG. 25, results 2500 correspond to testing the path finding system on a VM and results 2510 correspond to testing the path finding system on a VRE for optimizing a SPN knee model. The results displayed in FIGS. 20-25 can indicate that the path finding system can handle both testing environments (e.g., VM and VRE) and provide a summary specific to both environments.

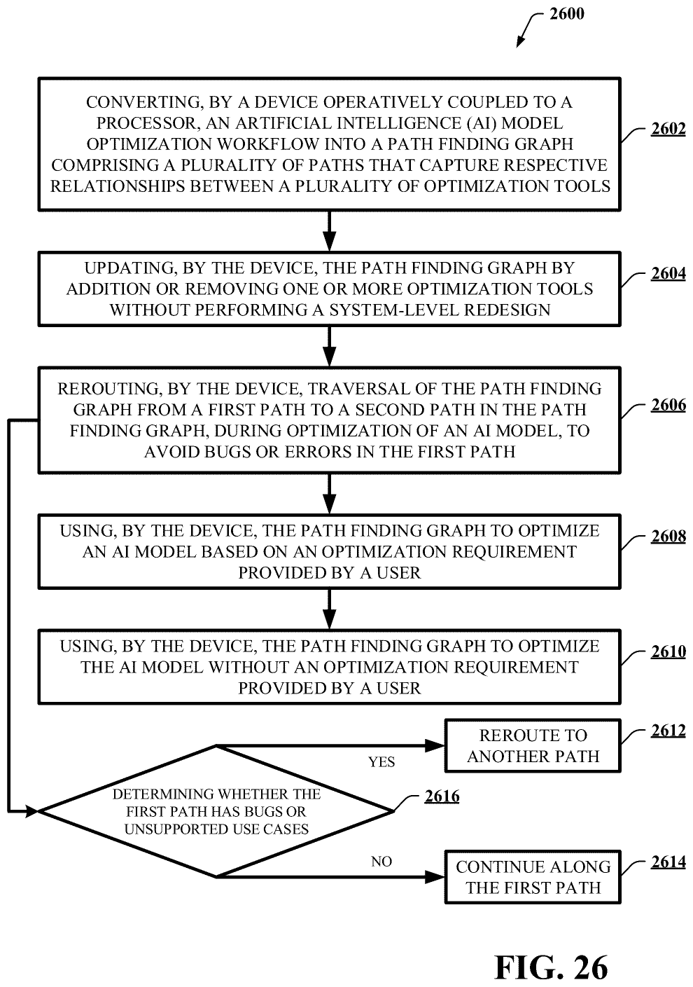

FIG. 26 illustrates a flow diagram of an example, non-limiting method 2600 that can enable a path finding system for AI model optimization in accordance with one or more embodiments described herein. One or more embodiments discussed with reference to FIG. 26 can be performed by one or more components of system 100 of FIG. 1. Repetitive description of like elements and/or processes employed in respective embodiments is omitted for sake of brevity.

At 2602, the non-limiting method 2600 can comprise converting (e.g., by graph generation component 108), by a device operatively coupled to a processor, an AI model optimization workflow into a path finding graph comprising a plurality of paths that can capture respective relationships between a plurality of optimization tools.

At 2604, the non-limiting method 2600 can comprise updating (e.g., by graph update component 110), by the device, the path finding graph by addition or removing one or more optimization tools without performing a system-level redesign.

At 2606, the non-limiting method 2600 can comprise rerouting (e.g., by graph solver component 112), by the device, traversal of the path finding graph from a first path to a second path in the path finding graph, during optimization of an AI model, to avoid bugs or errors in the first path.

At 2616, the non-limiting method 2600 can comprise determining whether the first path has bugs or unsupported use cases.

If yes, at 2612, the non-limiting method 2600 can comprise rerouting traversal of the path finding graph to another path. If no, at 2614, the non-limiting method 2600 can comprise continuing traversal of the path finding graph along the first path.

For example, the path finding graph can offer multiple routes from one optimization tool to another. In the path finding graph, certain paths from a first optimization tool to a second optimization tool can become blocked due to bugs, errors, and/or unsupported use cases, etc. In such a scenario, graph solver component 112 can traverse all paths from the first optimization tool to the second optimization tool to identify an error-free path between the first optimization tool and the second optimization tool. For example, graph solver component 112 can perform auto-rerouting from a blocked path of the path finding graph to another path to identify the error-free path. In various embodiments, non-limiting method 2600 can employ (e.g., at 2608) the error-free path of the path finding graph to optimize an AI model based on an optimization requirement. The optimization requirement can comprise optimizing the AI model to a specific target framework, while conditioning the AI model on inferencing deployment constraints. For example, given a TensorFlow™ model, a user can aim to optimize (e.g., using non-limiting method 2600) the TensorFlow™ model to an OpenVINO™ model such that the TensorFlow™ model can run on the CPU of a Linux® machine.

At 2608, the non-limiting method 2600 can comprise using (e.g., by AI model optimization component 114), by the device, the path finding graph to optimize an AI model based on an optimization requirement provided by a user.

At 2610, the non-limiting method 2600 can comprise using (e.g., by AI model optimization component 114), by the device, the path finding graph to optimize the AI model without an optimization requirement provided by a user.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively convert an AI model optimization workflow into a path finding graph as the one or more embodiments described herein can enable this process. And, neither can the human mind nor a human with pen and paper optimize AI models using different optimization tools comprised in the path finding graph, as conducted by one or more embodiments described herein.

Various embodiments here can lead to faster inferencing speed of AI models, which can improve user experience related to medical AI products on existing hardware. Alternatively, various embodiments herein can enable use of less expensive hardware while maintaining speed requirements, potentially lowering a cost of AI products manufactured by a company. For customers internal to a company, the various embodiments herein can streamline a model optimization workflow, significantly saving time and resources needed on AI model optimization and model deployment. As stated elsewhere herein, the various embodiments can provide an extensive scope of support optimization and assist companies with remaining abreast with latest technologies that can become available in the market by employing a systematic abstraction using the path finding graph to integrate different optimization solutions (e.g., as opposed to being a predefined system). The various embodiments can assist with automatically traversing between/combining different optimization engines to find a best possible way to accelerate machine learning models.

In order to provide additional context for various embodiments described herein, FIG. 27 and the following discussion are intended to provide a brief, general description of a suitable computing environment 2700 in which the various embodiments described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 27, the example environment 2700 for implementing various embodiments of the aspects described herein includes a computer 2702, the computer 2702 including a processing unit 2704, a system memory 2706 and a system bus 2708. The system bus 2708 couples system components including, but not limited to, the system memory 2706 to the processing unit 2704. The processing unit 2704 can be any of various commercially available processors. Dual microprocessors and other multi-processor architectures can also be employed as the processing unit 2704.

The system bus 2708 can be any of several types of bus structure that can further interconnect to a memory bus (with or without a memory controller), a peripheral bus, and a local bus using any of a variety of commercially available bus architectures. The system memory 2706 includes ROM 2710 and RAM 2712. A basic input/output system (BIOS) can be stored in a nonvolatile memory such as ROM, erasable programmable read only memory (EPROM), EEPROM, which BIOS contains the basic routines that help to transfer information between elements within the computer 2702, such as during startup. The RAM 2712 can also include a high-speed RAM such as static RAM for caching data.

The computer 2702 further includes an internal hard disk drive (HDD) 2714 (e.g., EIDE, SATA), one or more external storage devices 2716 (e.g., a magnetic floppy disk drive (FDD) 2716, a memory stick or flash drive reader, a memory card reader, etc.) and a drive 2720, e.g., such as a solid state drive, an optical disk drive, which can read or write from a disk 2722, such as a CD-ROM disc, a DVD, a BD, etc. Alternatively, where a solid state drive is involved, disk 2722 would not be included, unless separate. While the internal HDD 2714 is illustrated as located within the computer 2702, the internal HDD 2714 can also be configured for external use in a suitable chassis (not shown). Additionally, while not shown in environment 2700, a solid state drive (SSD) could be used in addition to, or in place of, an HDD 2714. The HDD 2714, external storage device(s) 2716 and drive 2720 can be connected to the system bus 2708 by an HDD interface 2724, an external storage interface 2726 and a drive interface 2728, respectively. The interface 2724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2712, including an operating system 2730, one or more application programs 2732, other program modules 2734 and program data 2736. All or portions of the operating system, applications, modules, or data can also be cached in the RAM 2712. The systems and methods described herein can be implemented utilizing various commercially available operating systems or combinations of operating systems.

Computer 2702 can optionally comprise emulation technologies. For example, a hypervisor (not shown) or other intermediary can emulate a hardware environment for operating system 2730, and the emulated hardware can optionally be different from the hardware illustrated in FIG. 27. In such an embodiment, operating system 2730 can comprise one virtual machine (VM) of multiple VMs hosted at computer 2702. Furthermore, operating system 2730 can provide runtime environments, such as the Java runtime environment or the .NET framework, for applications 2732. Runtime environments are consistent execution environments that allow applications 2732 to run on any operating system that includes the runtime environment. Similarly, operating system 2730 can support containers, and applications 2732 can be in the form of containers, which are lightweight, standalone, executable packages of software that include, e.g., code, runtime, system tools, system libraries and settings for an application.

Further, computer 2702 can be enable with a security module, such as a trusted processing module (TPM). For instance with a TPM, boot components hash next in time boot components, and wait for a match of results to secured values, before loading a next boot component. This process can take place at any layer in the code execution stack of computer 2702, e.g., applied at the application execution level or at the OS kernel level, thereby enabling security at any level of code execution.

A user can enter commands and information into the computer 2702 through one or more wired/wireless input devices, e.g., a keyboard 2738, a touch screen 2740, and a pointing device, such as a mouse 2742. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2704 through an input device interface 2744 that can be coupled to the system bus 2708, but can be connected by other interfaces, such as a parallel port, an IEEE 1394 serial port, a game port, a USB port, an IR interface, a BLUETOOTH® interface, etc.

A monitor 2746 or other type of display device can be also connected to the system bus 2708 via an interface, such as a video adapter 2748. In addition to the monitor 2746, a computer typically includes other peripheral output devices (not shown), such as speakers, printers, etc.

The computer 2702 can operate in a networked environment using logical connections via wired or wireless communications to one or more remote computers, such as a remote computer(s) 2750. The remote computer(s) 2750 can be a workstation, a server computer, a router, a personal computer, portable computer, microprocessor-based entertainment appliance, a peer device or other common network node, and typically includes many or all of the elements described relative to the computer 2702, although, for purposes of brevity, only a memory/storage device 2752 is illustrated. The logical connections depicted include wired/wireless connectivity to a local area network (LAN) 2754 or larger networks, e.g., a wide area network (WAN) 2756. Such LAN and WAN networking environments are commonplace in offices and companies, and facilitate enterprise-wide computer networks, such as intranets, all of which can connect to a global communications network, e.g., the Internet.

When used in a LAN networking environment, the computer 2702 can be connected to the local network 2754 through a wired or wireless communication network interface or adapter 2758. The adapter 2758 can facilitate wired or wireless communication to the LAN 2754, which can also include a wireless access point (AP) disposed thereon for communicating with the adapter 2758 in a wireless mode.

When used in a WAN networking environment, the computer 2702 can include a modem 2760 or can be connected to a communications server on the WAN 2756 via other means for establishing communications over the WAN 2756, such as by way of the Internet. The modem 2760, which can be internal or external and a wired or wireless device, can be connected to the system bus 2708 via the input device interface 2744. In a networked environment, program modules depicted relative to the computer 2702 or portions thereof, can be stored in the remote memory/storage device 2752. It will be appreciated that the network connections shown are example and other means of establishing a communications link between the computers can be used.

When used in either a LAN or WAN networking environment, the computer 2702 can access cloud storage systems or other network-based storage systems in addition to, or in place of, external storage devices 2716 as described above, such as but not limited to a network virtual machine providing one or more aspects of storage or processing of information. Generally, a connection between the computer 2702 and a cloud storage system can be established over a LAN 2754 or WAN 2756 e.g., by the adapter 2758 or modem 2760, respectively. Upon connecting the computer 2702 to an associated cloud storage system, the external storage interface 2726 can, with the aid of the adapter 2758 or modem 2760, manage storage provided by the cloud storage system as it would other types of external storage. For instance, the external storage interface 2726 can be configured to provide access to cloud storage sources as if those sources were physically connected to the computer 2702.

The computer 2702 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

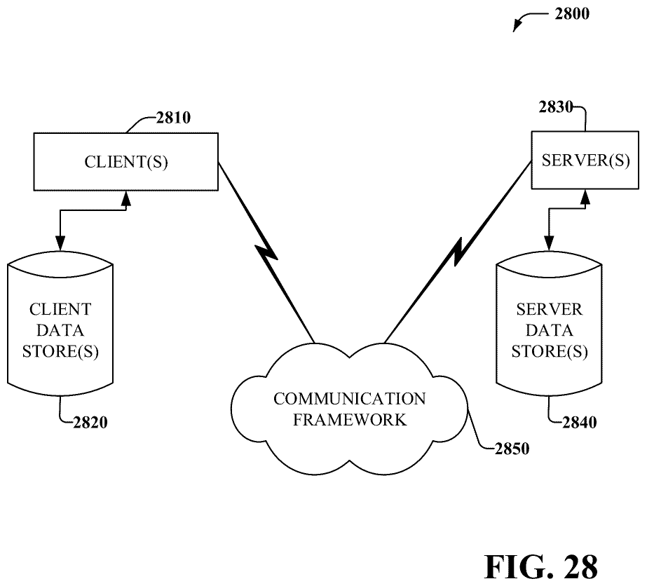

FIG. 28 is a schematic block diagram of a sample computing environment 2800 with which the disclosed subject matter can interact. The sample computing environment 2800 includes one or more client(s) 2810. The client(s) 2810 can be hardware or software (e.g., threads, processes, computing devices). The sample computing environment 2800 also includes one or more server(s) 2830. The server(s) 2830 can also be hardware or software (e.g., threads, processes, computing devices). The servers 2830 can house threads to perform transformations by employing one or more embodiments as described herein, for example. One possible communication between a client 2810 and a server 2830 can be in the form of a data packet adapted to be transmitted between two or more computer processes. The sample computing environment 2800 includes a communication framework 2850 that can be employed to facilitate communications between the client(s) 2810 and the server(s) 2830. The client(s) 2810 are operably connected to one or more client data store(s) 2820 that can be employed to store information local to the client(s) 2810. Similarly, the server(s) 2830 are operably connected to one or more server data store(s) 2840 that can be employed to store information local to the servers 2830.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer-executable components; and
a processor that executes the computer-executable components stored in the memory, wherein the computer-executable components comprise:
a graph generation component that converts an artificial intelligence (AI) model optimization workflow into a path finding graph comprising a plurality of paths that capture respective relationships between a plurality of optimization tools, wherein the path finding graph is employed to solve a graph traversal problem for an AI model optimization task based on a model optimization sequence.

2. The system of claim 1, wherein respective paths of the plurality of paths represent respective possibilities of conversions between optimization tools.

3. The system of claim 1, further comprising:
a graph update component that updates the path finding graph by addition or removing one or more optimization tools without performing a system-level redesign.

4. The system of claim 1, further comprising:
a graph solver component that reroutes from a first path to a second path in the path finding graph, during traversal of the path finding graph for optimization of an AI model, to avoid bugs or errors in the first path.

5. The system of claim 1, further comprising:
an AI model optimization component that uses the path finding graph to optimize an AI model based on an optimization requirement provided by a user.

6. The system of claim 5, wherein the AI model optimization component uses the path finding graph to optimize the AI model without the optimization requirement provided by the user.

7. The system of claim 1, wherein the path finding graph allows for optimizing an AI model to have an inferencing speed greater than a first defined threshold and resource usage lower than a second defined threshold, and wherein the AI model is integrated with medical imaging devices to provide real-time inferencing of medical images generated by the medical imaging devices.

8. A computer-implemented method, comprising:
converting, by a device operatively coupled to a processor, an AI model optimization workflow into a path finding graph comprising a plurality of paths that capture respective relationships between a plurality of optimization tools.

9. The computer-implemented method of claim 8, wherein respective paths of the plurality of paths represent respective possibilities of conversions between optimization tools.

10. The computer-implemented method of claim 8, further comprising:
updating, by the device, the path finding graph by addition or removing one or more optimization tools without performing a system-level redesign.

11. The computer-implemented method of claim 8, further comprising:
rerouting, by the device, traversal of the path finding graph from a first path to a second path in the path finding graph, during optimization of an AI model, to avoid bugs or errors in the first path.

12. The computer-implemented method of claim 8, further comprising:
using, by the device, the path finding graph to optimize an AI model based on an optimization requirement provided by a user.

13. The computer-implemented method of claim 8, further comprising:
using, by the device, the path finding graph to optimize the AI model without an optimization requirement provided by a user.

14. The computer-implemented method of claim 8, wherein the path finding graph allows for optimizing an AI model to have an inferencing speed greater than a first defined threshold and resource usage lower than a second defined threshold, and wherein the AI model is integrated with medical imaging devices to provide real-time inferencing of medical images generated by the medical imaging devices.

15. A computer program product for AI model inferencing optimization, the computer program product comprising a non-transitory computer readable memory having program instructions embodied therewith, the program instructions executable by a processor to cause the processor to:
convert an AI model optimization workflow into a path finding graph comprising a plurality of paths that capture respective relationships between a plurality of optimization tools.

16. The computer program product of claim 15, wherein respective paths of the plurality of paths represent respective possibilities of conversions between optimization tools.

17. The computer program product of claim 15, wherein the program instructions are further executable by the processor to cause the processor to:
update the path finding graph by addition or removing one or more optimization tools without performing a system-level redesign.

18. The computer program product of claim 15, wherein the program instructions are further executable by the processor to cause the processor to:
reroute traversal of the path finding graph from a first path to a second path in the path finding graph, during optimization of an AI model, to avoid bugs or errors in the first path.

19. The computer program product of claim 15, wherein the program instructions are further executable by the processor to cause the processor to:
use the path finding graph to optimize an AI model based on an optimization target provided by a user.

20. The computer program product of claim 15, wherein the program instructions are further executable by the processor to cause the processor to:
use the path finding graph to optimize an AI model without an optimization target provided by a user.
